(19) United States
(12) Patent Application Publication
(10) Pub. No.: US 2008/0098469 A1
(43) Pub. Date: Apr. 24, 2008

(54) AUTHENTICATION ENTITY DEVICE, VERIFICATION DEVICE AND AUTHENTICATION REQUEST DEVICE

(76) Inventors: Tomoaki Morijiri, Chofu-shi (JP); Koji Okada, Tokyo (JP); Hidehisa Takamizawa, Fuchu-shi (JP); Asahiko Yamada, Tokorozawa-shi (JP); Tatsuro Ikeda, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/946,841

(22) Filed: Nov. 29, 2007

Related U.S. Application Data
(63) Continuation of application No. PCT/JP2006/313615, filed on Jul. 7, 2006.

(30) Foreign Application Priority Data
Jul. 7, 2005 (JP) 2005-199189

(51) Int. Cl. H04L 9/32

(52) U.S. Cl. 726/5

(57) ABSTRACT

A verification device transmits challenge information to a first entity device, and for each authentication context received in return, verifies that challenge information identical to the challenge information transmitted in advance is described, to thereby confirm that the authentication context is the current one. As a result, a repetitive attack in which the past authentication context is repeatedly used is prevented and the security against repetitive attacks is improved.

### CROSS-REFERENCE TO RELATED APPLICATIONS

This is a Continuation Application of PCT Application No. PCT/JP2006/313615, filed Jul. 7, 2006, which was published under PCT Article 21(2) in Japanese.

This application is based upon and claims the benefit of priority from prior Japanese Patent Application No. 2005-199189, filed Jul. 7, 2005, the entire contents of which are incorporated herein by reference.

### BACKGROUND OF THE INVENTION

1. Field of the Invention

The present invention relates to an authentication device, a verification device and an authentication request device for notifying a verifier of the authentication context assuring the result of execution of the authentication, or for example, an authentication device, a verification device and an authentication request device capable of improving the safety against the repetitive attacks which repeatedly use the past authentication contexts.

2. Description of the Related Art

In communications and services via a network, the authentication of the other party of the communication is an essential technical element. Especially, with the recent extension of an open network environment and the development of the federation technology among distributed service resources, the objects of authentication have come to cover even the device terminals as well as the users.

In this situation, authentication means in a variety of layers is implemented. An example is SSL (secure sockets layer)/TLS (transport layer security) in the session layer of the OSI 7 layer model. See, for example, [SSL3.0] A. Frier, P. Karlton, and P. Kocher, “The SSL 3.0 Protocol”, Netscape Communications Corp., Nov. 18, 1996 (Document 1) and [TLS1.0] T. Dierks, C. Allen, “The TLS Protocol Version 1.0”, RFC2246, January 1999, <http://www.jetf.org/rfc/rfc2246.txt> (Document 2). SSL/TLS can provide a secure communication transparent to the upper layer, and therefore, has extended widely as a standard secure communication protocol. In SSL/TLS, the server authentication and the client authentication are supported based on the public key certificate as an authentication mechanism.

Also, IPsec is available as a secure communication aimed at IP (Internet Protocol) providing a communication protocol for the network layer of the OSI 7 layer model. See, for example, [IPsec] S. Kent, R. Atkinson, “Security Architecture for the Internet Protocol”, November 1998, <http://www.jetf.org/rfc/rfc2401.txt> (Document 3). IPsec, which is intended for authentication and encryption at the IP packet level and realizes secure communication by host, is used for VPN (Virtual Private Network), etc. IPsec supports the authentication of the other party of communication with a known common key, and dynamic authentication can use the mechanism of IKE or IKEv2 providing a host security association mechanism.

As an industrial standard specification stipulating the statement of security on the user authentication, on the other hand, SAML (Security Assertion Markup Language) has been conceived. Refer, for example, to [SAML]OASIS Security Services TC, “Security Assertion Markup Language (SAML) vol. 1”, September 2003”<http://www.oasis-open.org/committees/tc_home.php?wg_ab brev=security> (Document 4). SAML is a mechanism for electronically assuring by expressing the statement relating to the client security or policy decision in XML form.

As described above, the authentication means through a network, the application of which has advanced in various layers, constitutes an essential technical element for communications and services as described above.

Also, in the case where the object of authentication is an individual person, the technique for confirming the particular individual person as a principal is currently being followed closely. Normally, the requirement for authentication is the strict identification or verifying of the person to be authenticated (hereinafter sometimes referred to as the object person). In the case where the object person is an individual, the identification technique for strictly confirming that the particular individual is the principal (hereinafter referred to as the principal identification) is required.

A current promising technique for principal confirmation involves biometrics (biometric verifying/authentication technique). Biometrics is a technique in which a unique physical feature or characteristic of an individual person is verified with the biometric information registered in advance (hereinafter referred to as the biometric template) for the principal identification of an individual. The biometric information used includes fingerprints, iris, retina, face, voice, key stroke and signature.

Biometrics, which differs from existing authentication methods such as passwords, uses biometric information that can never be lost or forgotten, and therefore alleviates the burden on the user. Also, the use of biometric information presupposes the difficulty in duplication, and therefore, can constitute an effective measure to prevent a third party user from assuming the identity as the principal.

Further, open networks, which typically include the internet, have extended to such an extent that the move to use biometrics has been heightened as a method of authenticating the other party of communication over a network in electronic commercial transactions. Also, the principal confirmation of a legitimate holder of an ID card using biometrics is under study.

The use of biometrics on the assumption of the communication through the network poses the problem of security of the matching result and the matching information on the network path. The combination with a secure medium such as a public key infrastructure or IC card, however, has reduced the risk of theft and alteration of the critical information such as the biometric information in the devices on the communication path.

A multimodal biometrics system for overall principal identification by combining a plurality of biometrics methods as described above has made possible a highly accurate identification of the principal.

Most of the currently available authentication techniques, however, presuppose that the processes comprising authentication are managed in the same management domain, and therefore, a problem is posed that the assurance of each process is not taken into consideration.

In biometrics, for example, how the processes comprising authentication (hereinafter sometimes referred to as authentication subprocesses) including the functions of capturing and matching the biometric information are arranged on the devices and equipment is often determined uniquely for each system. Specifically, in the matching-on-card (MOC) model constituting one of the biometrics models, for example, the function to capture the biometric information is realized within a scanner, and the function to match the biometric information and the function to manage the biometric template are realized within a card (smart card, etc.).

As described above, the authentication subprocesses often involve a different management entity for a different process. As a result, it is difficult on the part of the authentication result verifier to positively determine whether the authentication subprocesses for each management entity are legitimate or not.

The resulting failure to determine the legitimacy of the authentication subprocesses may deteriorate the reliability of the entire authentication process as an integration of the authentication subprocesses. This risk is considered conspicuous, especially for authentication processes on an open network environment that do not always operate within the same management domain.

As a technique for solving this problem, an authentication system is known which uses an authentication context typically including a biometric authentication context. See, for example, “Koji Okada, Tatsuro Ikeda, Hidehisa Takamizawa, Toshiaki Saisho, “Extensible Personal Authentication Framework using Biometrics and PKI”, Pre-Proceedings of The 3rd International Workshop for Applied PKI (IWAP2004), pp. 96-107 (Document 5). The authentication context is a technique in which the management entity (entity device) executing each subprocess for principal identification assures the execution result, thereby making it possible to verify the legitimacy of the result of execution of each subprocess on the part of the verifier.

Specific execution steps are described below.

First, the management entity executing each subprocess holds the confidential information (such as the confidential key for the public key encryption system). For principal identification, each management entity generates an authenticator (such as a digital signature) using the confidential information thus held for the execution result of the subprocess executed by itself, and outputs by shaping the execution result and the authenticator in accordance with a specified format called the authentication context. Then, the management entities exchange the authentication contexts in the order of execution of the principal identification. The last management entity transmits the last output authentication context to the verifier.

The verifier can verify the legitimacy of the result of principal identification execution by verifying the legitimacy of the authenticator described in the authentication context (using, for example, the public key corresponding to the digital signature).

### BRIEF SUMMARY OF THE INVENTION

The authentication system described above in Document 5 normally poses no problem. The detailed study carried out by the present inventor, however, indicates the likelihood of the following four inconveniences, (1) to (4), each considered to have an individual margin of improvement.

(1) The first inconvenience is that in the case of “repetitive attacks” in which the past authentication context is used repeatedly, the execution result in the past authentication context may be misinterpreted as the present right execution result.

Let us add that “repetitive attacks” means an attack in which the authentication context generated in the past for principal identification is transmitted to the verifier as the authentication context for the present principal identification. In this repetitive attack, the verifier misinterprets the execution result of the principal identification as the right one.

In the case where the latter principal identification (matching process, etc.) is conducted with the authentication context output by the scanner in the past in the MOC model, for example, the verifier fails to detect that the biometric information in the authentication context is the one scanned in the past, and erroneously determines it as the correct biometric information.

With regard to the first inconvenience, there is considered room to improve the security against repetitive attacks in which the past authentication context is repeatedly used.

(2) The second inconvenience is that in the case where a “false replacement” of the biometric information is received, the biometric information after replacement is erroneously used for the matching process.

Let us add that during the authentication, there may be some information (confidential information) of which the transmission to the verifier is not desired, to protect privacy. The confidential information is, for example, biometric information such as fingerprints. The situation prevails, on the other hand, in which the principal identification cannot be obtained without exchanging the biometric information among the management entities executing the subprocess.

In the technique described in Document 5, therefore, a method has been proposed in which the information (hash value, etc.) related to the biometric information is described in the authentication context, and the biometric information and the authentication context are delivered separately from each other, thereby preventing the biometric information from being included in the authentication context transmitted to the verifier.

In the case where the transmission of the biometric information to the verifier is not desired in the MOC model, for example, the scanned biometric information and the authentication context including the information (such as the hash value) related to the particular biometric information are transmitted separately from each other to the card from the scanner. In the process, by wrongly replacing only the transmitted biometric information, the illegal principal identification may succeed. This is due to the fact that the difference between the scanned biometric information and the replacement biometric information cannot be verified, and the illegal biometric information after wrong replacement is used for the card matching process.

Document 5 proposes a preventive method in which each management entity verifies the correspondence between the input biometric information and the related information (such as the hash value) in the authentication context. Nevertheless, each management entity is a scanner or a smart card comparatively low in calculation ability. The verification by such a management entity is not effective from the realistic point of view.

With the second inconvenience, therefore, the security is considered required to be improved against the attack by wrong replacement of the confidential information such as biometric information.

(3) The third inconvenience is that the various execution environments of the requester are grasped by the verifier in the protocol to assure that the security level of the execution entity (requester) of the principal identification meets the security policy of the verifier.

Specifically, according to the technique described in Document 5, the verifier transmits the profile list request information to the requester at the time of executing the authentication. The profile is the information defining the execution environments such as the combination of the management entities executing the principal identification, the subprocesses executed by each management entity, the rule on information exchange between the management entities and the security execution rule (including the security level). The profile list is the information including a plurality of the profiles described as a list.

The requester, in response to the profile list request information, creates a profile list including all the profiles executable by combination of the management entities held by himself, and transmits it to the verifier. From the profile list thus received, the verifier determines a profile to be executed in accordance with the security policy set by himself. The security policy is the information describing the security level that can be accepted by the verifier. By comparing the security level in the security policy with the security level in the profile, the profile meeting the requirement of the security policy can be assured.

The verifier then designates the determined profile for the requester. The requester executes the principal identification in accordance with the profile thus designated.

The process described above, in which the various execution environments of the requester are grasped by the verifier from the profile list transmitted by the requester, is not desirable from the viewpoint of the privacy protection of the requester.

With regard to the third inconvenience, therefore, a margin of improvement is considered to exist in hiding the various execution environments of the requester from the verifier.

(4) The fourth inconvenience is the low communication efficiency of the authentication context.

A verification device 30 may verify the authentication context by accessing the static information (the information identical among the authentication sessions) in the authentication context. The static information includes the information on the maker of the entity device, the accuracy information of the capture device in biometrics authentication, and the information for evaluation of the biometric template.

In any case, the static information is accessed by transmitting the authentication context including the same static information to the verification device 30 at each time of authentication, and therefore, the efficiency is low in terms of communication traffic.

With regard to the fourth inconvenience, therefore, a margin of improvement is considered to exist for a higher efficiency of communication of the authentication context.

A first object of this invention is to provide an authentication device and a verification device in which the security can be improved against the repetitive attacks in which the past authentication context is repeatedly used.

A second object of this invention is to provide an authentication device and a verification device in which the security can be improved against an illegal (false) replacement attack of the confidential information.

A third object of this invention is to provide an authentication device, a verification device and an authentication request device in which the various execution environments of the requester can be hidden from the verifier.

A fourth object of this invention is to provide an authentication device, a verification device and an authentication request device in which the communication efficiency of the authentication context can be improved.

According to a first aspect of the present invention, there is provided an authentication system comprising a plurality of authentication entity devices which individually execute authentication subprocesses making up an authentication process and a verification device which verifies the authentication process executed by the entity devices, wherein the authentication entity devices each include: a challenge information receiving module configured to receive a challenge information generated by the verification device; a confidential information storage module configured to store a confidential information for the verification; an authenticator generating module configured to generate an authenticator for the contents of execution of the authentication subprocesses and the challenge information based on the confidential information; an authentication context generating module configured to generate an authentication context describing the authenticator, the contents of execution and the challenge information in accordance with a specified format; and an authentication context transmitting module configured to transmit the authentication context, and the verification device includes: a verification information storage module configured to store an authenticator verification information corresponding to the confidential information; a challenge generating module configured to generate the challenge information; a challenge storage module configured to store the challenge information; a challenge information transmitting module configured to transmit the challenge information; an authentication context receiving module configured to receive each authentication context generated by the authentication entity devices; a challenge verification module configured to verify whether the challenge information identical to the challenge information in the challenge storage module is described for each of the authentication contexts received; an authenticator verification module configured to verify the authenticator for each authentication context based on the authenticator verification information; and an authentication context verification module configured to verify the legitimacy of each authentication context based on the verification result of each of the verification module.

According to the first aspect of the invention, the verification device verifies, for each authentication context received, that the challenge information identical to the challenge information in the challenge storage module is described in the authentication context, thereby making it possible to confirm that each authentication context is the present authentication context. Therefore, repetitive attacks that repeatedly use the past authentication context are prevented, which improves security against repetitive attacks.

According to a second aspect of the present invention, there is provided an authentication system comprising a plurality of authentication entity devices which individually execute authentication subprocesses making up an authentication process and a verification device which verifies the authentication processes executed by the entity devices, wherein the authentication entity devices include at least one first-stage authentication entity device and at least one second-stage authentication entity device the first-stage authentication entity device includes: a first-stage hash value generating module configured to generate a first-stage hash value for a confidential execution content which is included in the execution content of the authentication subprocesses and which is input to a second-stage authentication subprocess and hidden from the verification device; a first-stage confidential information storage module configured to store a confidential information for the verification; a first-stage authenticator generating module configured to generate an authenticator for the contents of execution of the authentication subprocess and the first-stage hash value based on the confidential information; a first-stage authentication context generating module configured to generate an authentication context describing, in accordance with a specified format, the authenticator, the execution content other than for the first-stage hash value and the first-stage hash value; and a first-stage transmitting module configured to transmit the authentication context and the confidential execution content, the second-stage authentication entity device includes: a confidential execution content receiving module configured to receive the confidential execution content transmitted; a second-stage hash value generating module configured to generate a second-stage hash value for the confidential execution content received; a second-stage confidential information storage module configured to store the confidential information for the verification; a second-stage authenticator generating module configured to generate an authenticator for the execution content of the authentication subprocess and the second-stage hash value based on the confidential information; a second-stage authentication context generating module configured to generate an authentication context describing the authenticator, the execution content and the second-stage hash value in accordance with a specified format; and a second-stage transmitting module configured to transmit the authentication context, and the verification device includes: a verification information storage module configured to store an authenticator verification information corresponding to the confidential information; an authentication context receiving module configured to receive the authentication contexts generated by the authentication entity devices; a hash value comparative verification module configured to verify by comparison that the first-stage hash value and the second-stage hash value contained in the authentication context received are identical to each other; an authenticator verification module configured to verify the authenticator for each of the authentication contexts based on the authenticator verification information; and an authentication context verification module configured to verify the legitimacy of the authentication contexts based on the verification result by the verification module.

According to the second aspect, the verification device verifies that the hash values included in the authentication contexts are identical to each other, thereby making it possible to confirm that the contents of the confidential execution of the first-stage authentication subprocess is identical to the contents of the confidential execution of the second-stage authentication subprocess. Therefore, the security is improved against illegal replacement attacks of the confidential information.

According to a third aspect of the present invention, there is provided an authentication system according to the first or second aspect, comprising an authentication request device which relays the communication between the verification device and the authentication entity devices, wherein the verification device includes: a profile list generating module configured to generate the profile list specifying an execution environment acceptable for execution of the authentication subprocesses; and a list transmitting module configured to transmit the profile list to the authentication request device, the authentication request device includes: a profile list receiving module configured to receive the profile list; a function list receiving module configured to receive, for each authentication entity device, a function list specifying the functions of executing the authentication subprocesses; a profile determining module configured to determine an execution profile in such a manner as to meet the requirements of both the profile list and the function list; and an execution profile transmitting module configured to transmit the execution profile to the authentication entity devices, and the authentication entity devices each include: an execution profile receiving module configured to receive the execution profile from the authentication request device; and an authentication subprocess execution module configured to execute the authentication subprocesses based on the execution profile.

According to the third aspect, in addition to the operation of the first or second aspect, the authentication request device determines an execution profile indicating the execution environment of each authentication entity device in such a manner as to meet the requirements of both the profile list indicating the execution environment acceptable by the verification device and the function list of each authentication entity device. Thus, the various execution environments of each entity device not related to the execution of authentication can be hidden from the verification device, and therefore, the privacy of the requester in each authentication entity device can be protected.

According to a fourth aspect of the present invention, there is provided an authentication system according to any one of the first to third aspects, wherein the authentication entity devices each include link destination information storage module configured to storing link destination information which is smaller in data amount than static information having the same content for each authentication session and which is adapted to acquire the static information, the authentication context generating module generates the authentication context in such a manner as to include the link destination information in place of the static information, and the verification device includes: a module configured to acquire the static information based on the link destination information in the authentication content received; and a verification module configured to verify the authentication process based on the static information and the execution content in the authentication context.

According to the fourth aspect, in addition to the operation of the first to third aspects, each entity device generates an authentication context in such a manner as to include the link destination information for acquiring the static information smaller in data amount than the static information indicating the same contents for each authentication. Thus, the size of the authentication context is reduced, and therefore, the communication traffic between the authentication request device and the verification device can be reduced, which improves the communication efficiency of the authentication context.

Although each aspect described above is expressed as a “system” including the devices, the invention is not limited to such a configuration, and the expression “apparatus”, “program”, “computer readable storage medium” or “method” may be used to include each device or for each device.

### BRIEF DESCRIPTION OF THE SEVERAL VIEWS OF THE DRAWING

FIG. 1 is a schematic diagram showing a configuration of an authentication system according to a first embodiment of the invention.

FIG. 2 is a flowchart for explaining an authentication process according to the same embodiment.

FIG. 3 is a schematic diagram showing a configuration of each entity device according to the same embodiment.

FIG. 4A is a schematic diagram showing a configuration of an authentication context according to the same embodiment.

FIG. 4B is a schematic diagram showing a configuration of the authentication context according to the same embodiment.

FIG. 5 is a schematic diagram showing a configuration of a verification device according to the same embodiment.

FIG. 6 is a flowchart for explaining the operation according to the same embodiment.

FIG. 7 is a schematic diagram showing a configuration of an authentication system according to a second embodiment of the invention.

FIG. 8 is a schematic diagram showing a configuration of each entity device according to the same embodiment.

FIG. 9 is a schematic diagram showing a configuration of a verification device according to the same embodiment.

FIG. 10 is a schematic diagram showing a configuration of an authentication system according to a third embodiment of the invention.

FIG. 11 is a schematic diagram showing a configuration of an authentication request device according to the same embodiment.

FIG. 12 is a schematic diagram for explaining a profile list according to the same embodiment.

FIG. 13 is a schematic diagram for explaining an execution profile according to the same embodiment.

FIG. 14 is a schematic diagram showing a configuration of each entity device according to the same embodiment.

FIG. 15 is a sequence diagram for explaining the operation according to the same embodiment.

FIG. 16 is a schematic diagram showing a configuration according to a modification of the same embodiment.

FIG. 17 is a schematic diagram showing a configuration of an authentication system according to a fourth embodiment of the invention.

FIG. 18 is a schematic diagram showing an example of a template certificate according to the same embodiment.

FIG. 19 is a schematic diagram showing a configuration of each entity device according to the same embodiment.

FIG. 20A is a schematic diagram showing a configuration of an authentication context according to the same embodiment.

FIG. 20B is a schematic diagram showing a configuration of the authentication context according to the same embodiment.

FIG. 21 is a schematic diagram showing a configuration according to a modification of the same embodiment.

FIG. 22 is a schematic diagram showing a configuration according to a modification of the same embodiment.

### DETAILED DESCRIPTION OF THE INVENTION

Each embodiment of the invention is explained in detail below with reference to the drawings.

### First Embodiment

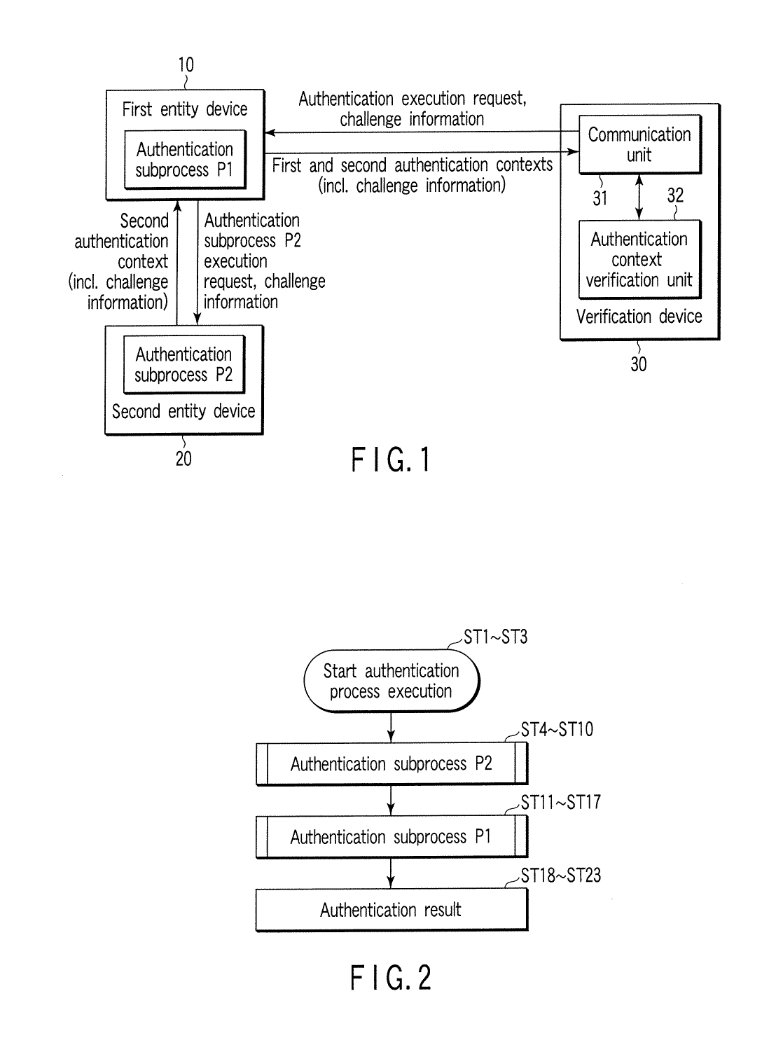

FIG. 1 is a schematic diagram showing the configuration of an authentication system according to a first embodiment of the invention. This authentication system, as shown in FIG. 2, is configured of two processes; an authentication subprocess P1 and an authentication subprocess P2. The authentication result is obtained based on the result of execution of the subprocesses P1, P2, which are executed by different entity devices 10, 20, respectively. Specifically, the authentication subprocess P1 is executed by the first entity device 10, and the authentication subprocess P2 by the second entity device 20.

The authentication subprocesses P1, P2 each constitute a component element of the authentication process, or specifically, one of the processes into which the whole authentication process is separated. In other words, assuming that the authentication process is the whole process, the authentication subprocesses P1, P2 each represent a sub-process of the whole process.

The authentication process may be separated into three or more instead of two authentication subprocesses, each of which may be executed by a different entity device. Also, the authentication subprocess in the second stage may or may not be executed with reference to the result of the authentication subprocess in the first stage.

The authentication system shown in FIG. 1 includes a verification device 30, the first entity device 10 and the second entity device 20. The verification device 30 includes a communication unit 31 communicable with the first entity device 10, and an authentication context verification unit 32 for verifying the authentication contexts generated by the first and second entity devices 10, 20.

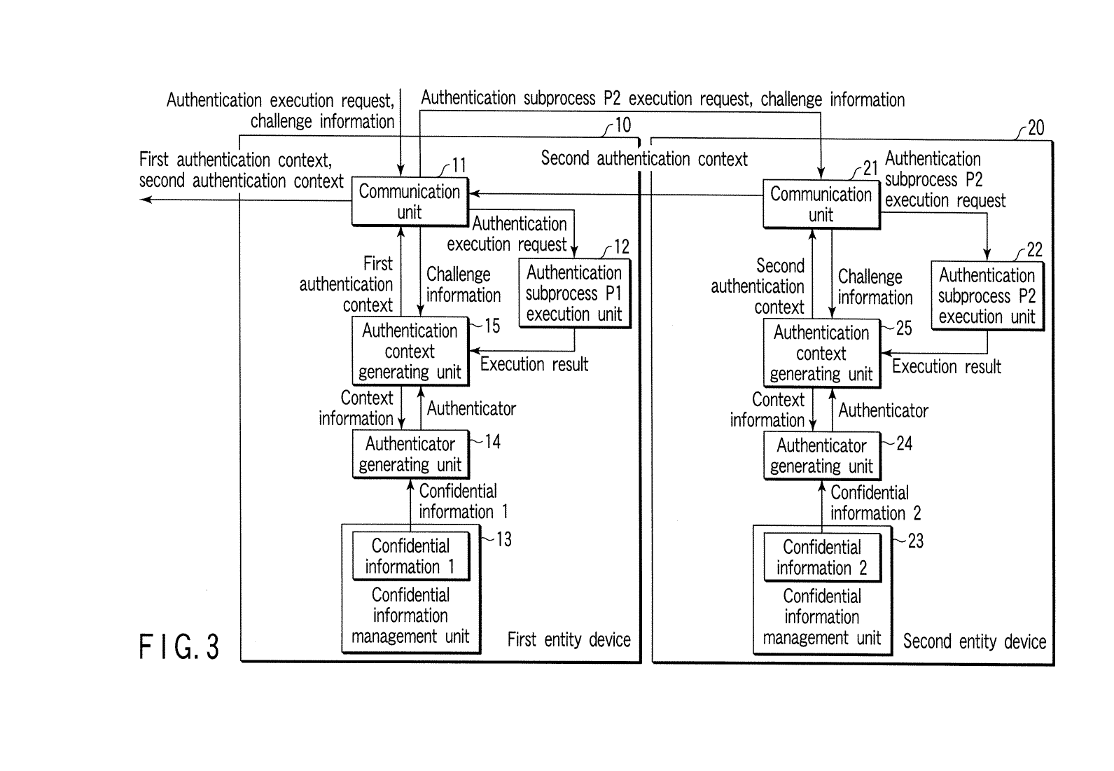

The entity devices 10, 20, as shown in FIG. 3, include communication units 11, 21, an authentication subprocess P1 execution unit 12, an authentication subprocess P2 execution unit 22, confidential information management units 13, 23, authenticator generating units 14, 24 and authentication context generating units 15, 25, respectively. The elements designated by the reference numerals on the order of ten are associated with the first entity device 10, and those on the order of twenty with the second entity device 20.

The communication units 11, 21 are for establishing communication between external devices such as the verification device 30 and the other entity devices 20, 10 on the one hand and the local devices 10, 20 on the other hand.

The communication unit 11, for example, has the function of receiving an authentication execution request and the challenge information from the verification device 30, the function of generating an authentication subprocess P2 execution request based on the received authentication execution request, the function of transmitting the authentication subprocess P2 execution request and the challenge information to the second entity device 20, the function of receiving the second authentication context from the second entity device, the function of sending out the aforementioned authentication execution request to the authentication subprocess P1 execution unit 12, the function of sending out the aforementioned challenge information to the authentication context generating unit 15 and the function of transmitting the first authentication context obtained from the authentication context generating unit 15 to the verification device 30 together with the aforementioned second authentication context.

The communication unit 21, on the other hand, has the function of receiving the authentication subprocess P2 execution request and the challenge information from the first authentication entity device 10, the function of sending out the received authentication subprocess P2 execution request to the authentication subprocess P2 execution unit 22, the function of sending out the received challenge information to the authentication context generating unit 25, and the function of transmitting the second authentication context obtained from the authentication context generating unit 25 to the first authentication entity device 10.

The authentication subprocess P1 execution unit 12 executes the aforementioned authentication subprocess P1 based on the authentication execution request received from the communication unit 11 and outputs the result of execution to the authentication context generating unit 15.

The authentication subprocess P2 execution unit 22 executes the aforementioned authentication subprocess P2 based on the authentication execution request received from the communication unit 21 and outputs the result of execution to the authentication context generating unit 25.

The confidential information management unit 13 is a storage device with the confidential information 1 for generating an authenticator stored therein in advance, and which is readable from the authenticator generating unit 14.

The confidential information management unit 23 is a storage device with the confidential information 2 for generating an authenticator stored therein in advance, and which is readable from the authenticator generating unit 24.

The authenticator generating units 14, 24 generate an authenticator using the confidential information 1, 2 read from the confidential information management units 13, 23 in respect of the data (execution result, challenge information, etc.) input from the authentication context generating units 15, 25, and send out the obtained authenticator to the authentication context generating units 15, 25.

The authenticator is defined as, for example, a digital signature or a message authentication code (MAC). The confidential information 1, 2 is the key information for generating the authenticator (to verify the authentication context), which is a private key for the public key encryption system in the case where the authenticator is the digital signature and a common key shared with the verification device 30 in advance in the case where the authenticator is the message authentication code.

The authentication context generating units 15, 25 describe and shape, in accordance with a specified format, the execution result of the authentication subprocess P1, P2 execution units 12, 22, the authenticators sent out from the authenticator generating units 14, 24 and the challenge information sent out from the communication units 11, 21, and send out the obtained authentication contexts to the communication units 11, 21.

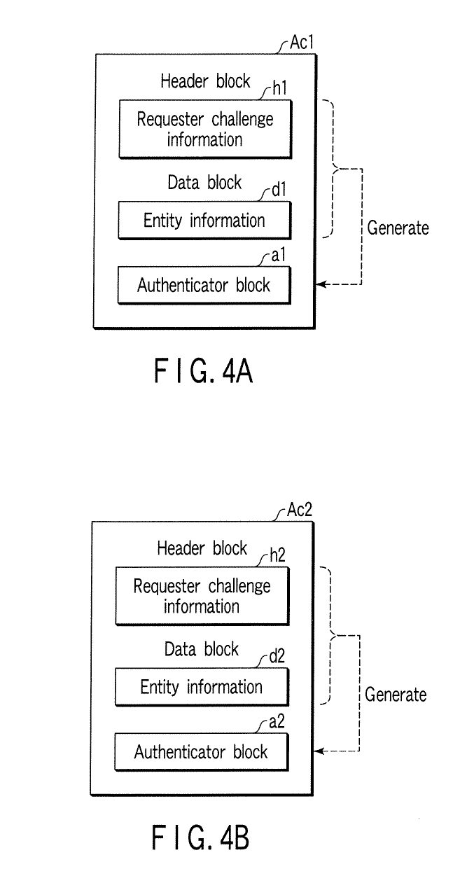

As shown in FIG. 4A, the format of the first authentication context Ac1 is configured of a header block h1, a data block d1 and an authenticator block a1. The first authentication context Ac1 is the information including the header block h1, the data block d1 and the authenticator block a1. Specifically, the first authentication context Ac1 is the information including the context information having the header block h1 and the data block d1 and the authenticator block a1 generated for the particular context information.

The header block h1 has described therein the requester or the like information specifying the authentication context Ac1 thereof and the challenge information or the like indicating the legitimacy of the authentication context. The challenge information is the variable information issued for each authentication execution request to prevent “the repetitive attack”, and can use a random number or a temporary variable such as time information or a serial number determined between the verification device and each entity device.

The data block d1 has described therein the entity information. The entity information includes, but is not limited to, the dynamic information (information generated for each authentication session) such as the execution result of the authentication subprocess P1 and can use the static information (the same information for all authentication sessions) such as the execution environment. The information usable as static information includes the information on the maker of the entity device, the accuracy information on the capture device in biometrics authentication and the evaluation information of the biometric template.

The authenticator block a1 has described therein the authenticator generated based on the confidential information 1 for the header block h1 and the data block d1.

The format of the second authentication context Ac2 is similar to the format of the first authentication context Ac1 as shown in FIG. 4B.

Similarly, therefore, the second authentication context A2 is the information including the header block h2, the data block d2 and the authenticator block a2. Specifically, the second authentication context Ac2 is the information including the context information having the header block h2 and the data block d2 and the authenticator block a2 generated for the particular context information. Let us add on the generation of the authenticator. The authenticator block a2 has described therein the authenticator generated based on the confidential information 2 for the header block h2 and the data block d2.

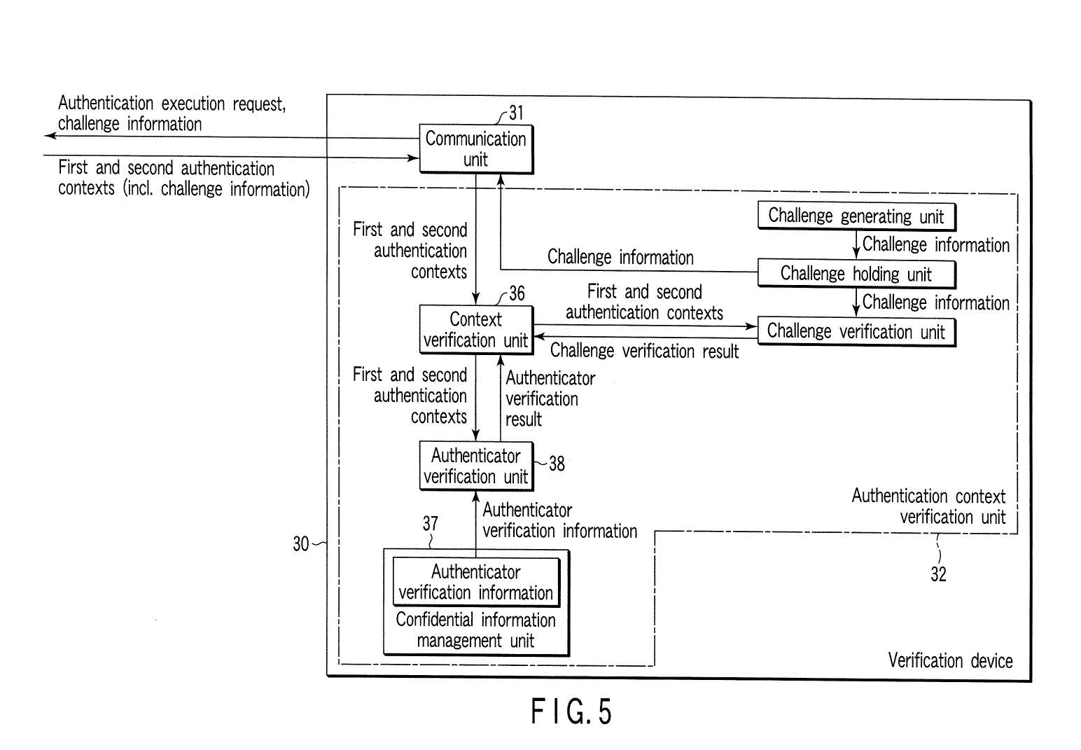

The verification device 30, on the other hand, includes the communication unit 31 and the authentication context verification unit 32 as shown in FIG. 5.

The communication unit 31 has the function of transmitting the authentication execution request and the challenge information in the challenge holding unit 34 to the first entity device 10, the function of receiving the first and second authentication contexts from the first entity device 10 and the function of sending out the received first and second authentication contexts to the authentication context verification unit 32.

The authentication context verification unit 32 includes a challenge generating unit 33, a challenge holding unit 34, a challenge verification unit 35, a context verification unit 36, a confidential information management unit 37 and an authenticator verification unit 38.

The challenge generating unit 33 has the function of generating the challenge information including the variable information such as a random number and holding the obtained challenge information in the challenge holding unit 34.

The challenge holding unit 34 is a memory for storing the challenge information, which is writable from the challenge generating unit 33 and readable from the communication unit 31 and the challenge verification unit 35, for example.

The challenge verification unit 35 has the function of verifying whether the same challenge information as the one in the challenge holding unit 34 is described or not for each authentication context received from the context verification unit 36 and the function of returning the obtained challenge information verification result to the context verification unit 36.

The context verification unit 36 has the function of sending out each authentication context, if received from the communication unit 31, to the authenticator verification unit 38, the function of receiving the authenticator verification result from the authenticator verification unit 38, the function of sending out each authentication context to the challenge verification unit 35, the function of receiving the challenge verification result from the challenge verification unit 35, the function of verifying the legitimacy of each authentication context based on the authenticator verification result and the challenge verification result, and the function of confirming the contents (execution environment, the execution result, etc.) of the authentication subprocesses P1, P2 based on the information of the data block in each authentication context.

The confidential information management unit 37 is a memory for storing the authenticator verification information corresponding to the confidential information 1, 2 and readable from the authenticator verification unit 38. The authenticator verification information, which is defined as the key information for verifying the authenticator (generated by the confidential information 1, 2), is a public key for the public key encryption system in the case where the authenticator is a digital signature or a common key shared with the entity devices 10, 20 in advance in the case where the authenticator is a message authentication code. The authenticator verification information, which is for verification of the authenticator generated by the confidential information 1, 2, constitutes the key information corresponding to the confidential information 1, 2. The word “corresponding” means the correspondence, for example, in the sense that the authenticator verification information is a decryption key in the case where the confidential information 1, 2 is an encryption key. the confidential information 1, 2 and the authenticator verification information, if corresponding to each other, therefore, may have different contents (private key versus public key) or the same contents (both common keys).

The authenticator verification unit 38 has the function of verifying the authenticator for each authentication context received from the context verification unit 36 based on the authenticator verification information in the confidential information management unit 37, and sending out the result of the authenticator verification to the context verification unit 36.

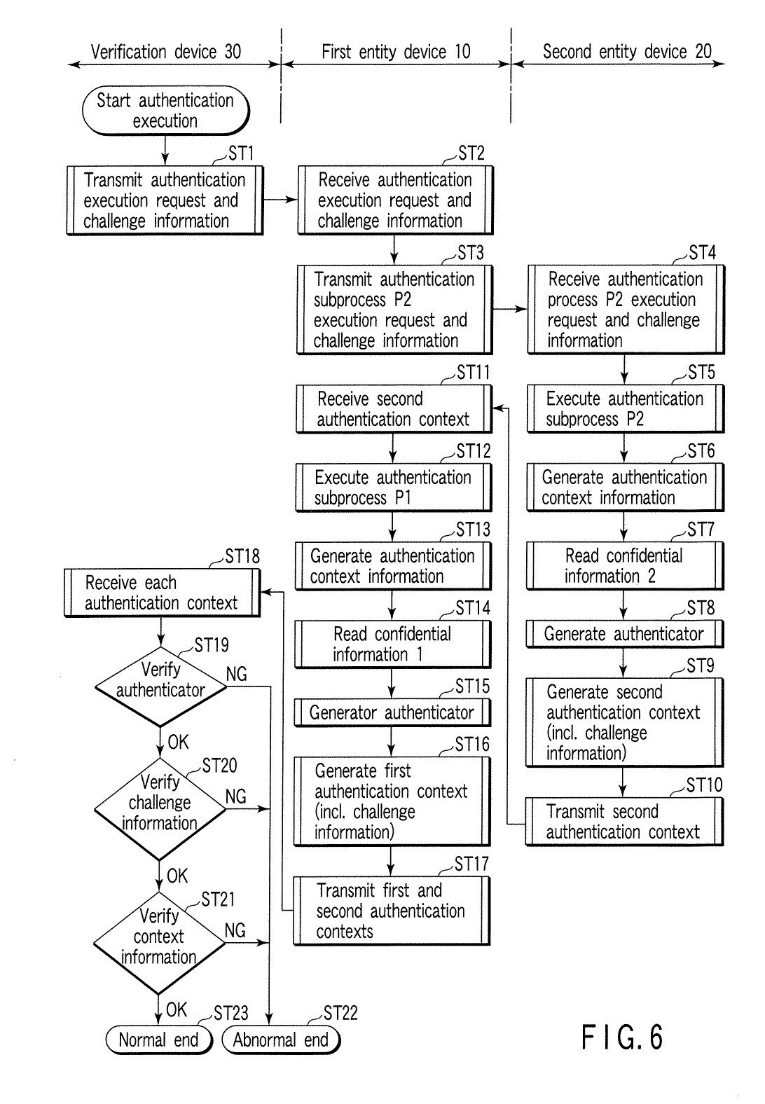

Next, the operation of the authentication system configured as described above is explained with reference to the flowchart of FIG. 6.

At the time of starting the execution of the authentication process, the challenge generating unit 33 of the verification device 30 generates the challenge information, which is temporarily held in the challenge holding unit 34. Incidentally, this challenge information is used later for verifying the correspondence between the authentication execution request and the authentication context.

After that, the verification device 30, through the communication unit 31, transmits the authentication execution request and the challenge information to the first entity device 10 (ST1). The authentication execution request includes the designation of the authentication process to be executed.

The first entity device 10, upon receipt of the authentication execution request and the challenge information (ST2), follows the authentication process predetermined or designated in the authentication execution request. Specifically, the first entity device 10 transmits the authentication subprocess P2 execution request and the challenge information to the second entity device 20 (ST3). This execution request may include the designation of the authentication process contained in the authentication execution request from the verification device 30 and the information required for execution of the authentication subprocess P2 (not shown) and held only by the first entity device 10.

The second entity device 20, upon receipt of the authentication subprocess P2 execution request and the challenge information from the first entity device 10 (ST4), follows the authentication process predetermined or designated by the authentication execution request from the verification device 30. Specifically, the second entity device 20 executes the authentication subprocess P2 through the authentication subprocess P2 execution unit 12 (ST5) and obtains the execution result.

Next, the authentication context generating unit 25, supplied with the challenge information and the result of execution of the authentication subprocess P2 input thereto, generates the second authentication context Ac2 in the format shown in FIG. 4B (ST6 to ST9).

Specifically, the authentication context generating unit 25 describes the header block h2 containing the requester and the challenge information and the data block d2 containing the execution result and the entity information, and thus generates the context information including the blocks h2, d2 (ST6). Incidentally, the challenge information is received in step ST4.

Next, the authenticator generating unit 24 reads the confidential information 2 for authenticator generation from the confidential information management unit 23 (ST7), and generates the authenticator using the confidential information 2 for the header block h2 and the data block d2 described above (ST8). Finally, the authenticator generated is described in the authenticator block a2 thereby to generate the second authentication context Ac2 including the blocks h2, d2, a2 (ST9).

The second entity device 20 transmits this second authentication context Ac2 to the first entity device 10 through the communication unit 21 (ST10).

The first entity device 10, upon receipt of the second authentication context Ac2 (ST1), executes the authentication subprocess P1 through the authentication subprocess P1 execution unit 12 (ST12) thereby to obtain the execution result.

Next, the authentication context generating unit 15, supplied with the execution result of the authentication subprocess P1 and the challenge information input thereto, generates the first authentication context Ac1 in the format shown in FIG. 4A (ST13 to ST16).

Specifically, the authentication context generating unit 15 describes the header block h1 containing the requester and the challenge information and the data block d1 containing the entity information such as the execution result and generates the context information including the blocks h1 and d1 (ST3). Incidentally, the challenge information is received in step ST2.

Next, the authenticator generating unit 14 reads the confidential information 1 from the confidential information management unit 13 for generating the authenticator (ST14). Then, the authenticator is generated using the confidential information 1 for the header block h1 and the data block d1 described above (ST15). Finally, the authenticator thus generated is described in the authenticator block a1 to thereby generate the first authentication context Ac1 including the blocks h1, d1, a1 (ST16).

The second entity device 20 transmits the first authentication context Ac1 and the second authentication context Ac2 to the verification device 30 through the communication unit 11 (ST17).

The verification device 30 receives the first and second authentication contexts Ac1, Ac2 (ST18). In the authentication context verification unit 32, the context verification unit 36 sends out the first and second authentication contexts to the authenticator verification unit 38. The authenticator verification unit 38, in order to confirm the completeness of the first and second authentication contexts Ac1, Ac2, verifies the authenticators in the authentication contexts Ac1, Ac2 based on the authenticator verification information in the confidential information management unit 37 (ST19), and sends out each authenticator verification result to the context verification unit 36.

Also, the context verification unit 36, in order to confirm that the first and second authentication contexts Ac1, Ac2 correspond to the authentication request, sends out the authentication contexts Ac1, Ac2 to the challenge information verification unit 35. Incidentally, only the header blocks h1, h2 including the challenge information may be sent out to the challenge information verification unit 35.

The challenge information verification unit 35, based on the challenge information in the challenge holding unit 34, verifies the challenge information of the authentication contexts Ac1, Ac2 (ST20), and returns the challenge information verification result to the context verification unit 36.

Further, the context verification unit 36 verifies the context information of the authentication contexts Ac1, Ac2 (ST21). Specifically, the context verification unit 36 verifies the result of execution of the authentication subprocesses P1, P2 included in the data blocks d1, d2 in the context information.

In the case where at least one of the verification results (the authenticator verification result, the challenge information verification result and the context information verification result) of steps ST19 to ST21 is abnormal, the context verification unit 36 determines that the authentication contexts Ac1, Ac2 are illegitimate and ends the process (ST22).

Also, in the case where all the verification results of steps ST19 to ST21 are legitimate, the context verification unit 36 determines that the authentication contexts Ac1, Ac2 are legitimate and ends the process (ST23). The verification process of each of steps ST19 to ST21 does not use the result of other verification processes, and therefore, can be executed in an arbitrary order but not in the order described above.

As described above, according to this embodiment, the verification device 30 transmits the challenge information to the first entity device 10, stores the particular challenge information in the challenge holding unit 34, and verifies that the same challenge information as that in the challenge holding unit 34 is described for each of the authentication contexts Ac1, Ac2 received in return, thereby confirming that the authentication contexts Ac1, Ac2 are the present ones.

In this way, repetitive attacks that repeatedly use the past authentication context are prevented, which improves the security against repetitive attacks.

### Second Embodiment

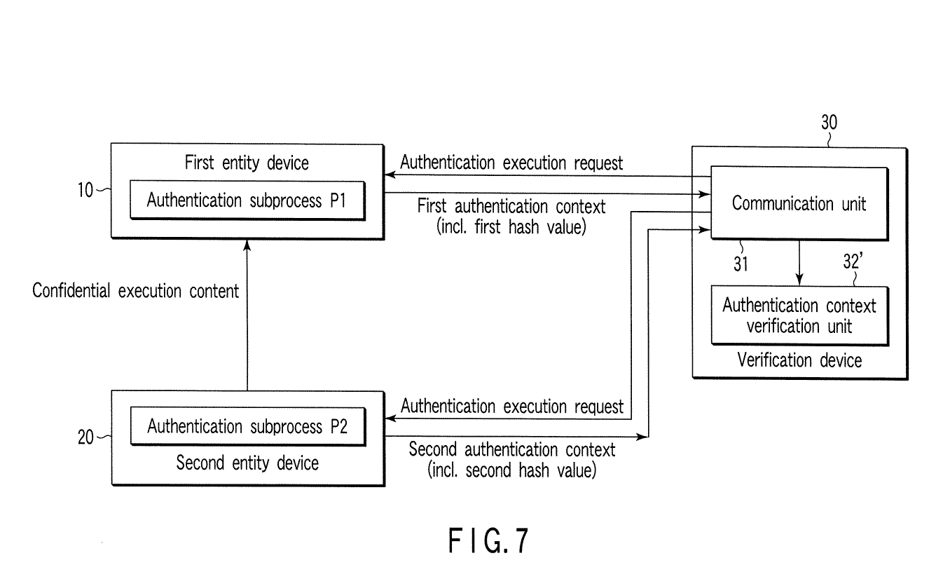

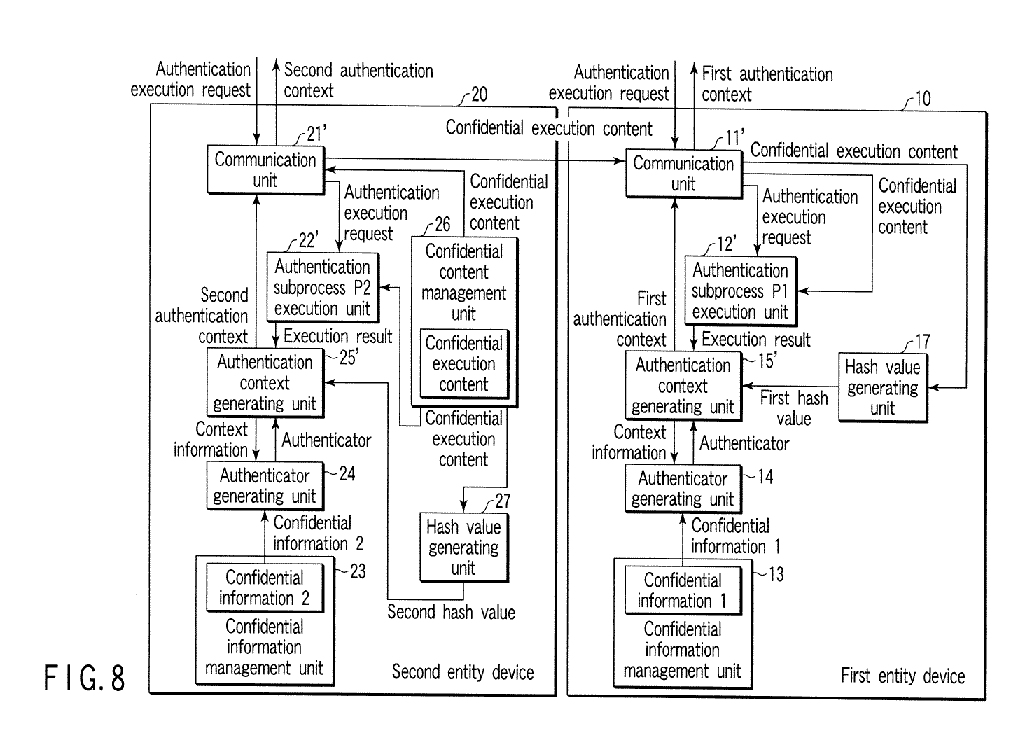

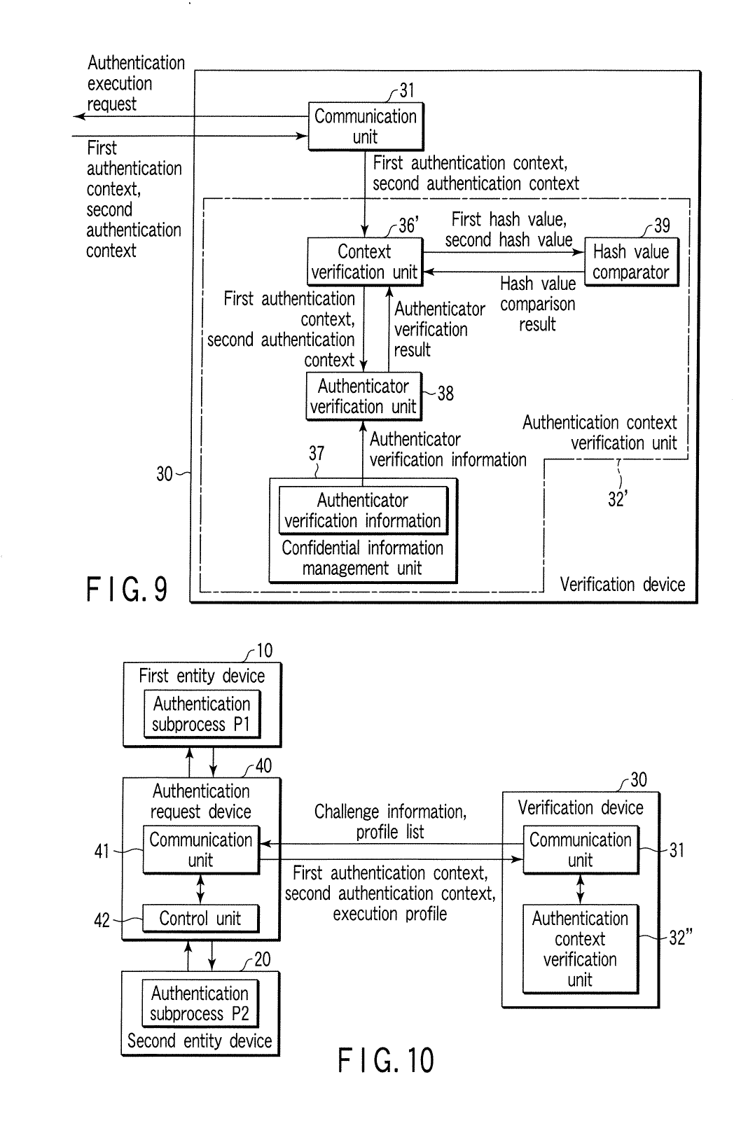

FIG. 7 is a schematic diagram showing the configuration of an authentication system according to a second embodiment of the invention, FIG. 8 a schematic diagram showing the configuration of each entity device of the same system, and FIG. 9 a schematic diagram showing the configuration of a verification device of the same system. In FIGS. 7 to 9, the component parts identical to those in the aforementioned drawings other than each device body are designated by the same reference numerals, respectively, and are not described in detail, while the component parts different from those in the aforementioned drawings are designated by different reference numerals or by attaching a dash or apostrophe and are not described in detail. Thus, only different component parts are mainly described below. Duplication of explanations is also avoided in the description of each embodiment below.

Specifically, the second embodiment is a modification of the first embodiment, and represents an authentication system dealing with the contents of the confidential execution providing the information to be hidden without notifying the verification device 30.

Examples of the confidential execution content include the biometric template for biometrics authentication and the biometric information acquired by the sensor at the time of execution. The biometric template is essential for biological authentication and is required to be shared between the entity devices 10, 20. From the viewpoint of privacy protection, this information is not desirably notified to the verification device 30.

The second entity device 20, as shown on the left side of FIG. 8, includes a confidential execution content management unit 26 and a hash value generating unit 27 in addition to the aforementioned configuration. Accordingly, the contents processed by a communication unit 21′, an authentication subprocess P2 execution unit 22′ and an authentication context generating unit 25′ are somewhat different.

The communication unit 21′ has the function of activating the authentication subprocess P2 execution unit 22′ upon receipt of the authentication execution request from the verification device 30, the function of transmitting the confidential execution content received from the confidential content management unit 26 to the first entity device 10 and the function of transmitting the second authentication context received from the authentication context generating unit 25′ to the verification device 30. Incidentally, the communication of the confidential execution content between the second and first entity devices 20, 10 is desirably hidden from outside using a secure communication path established by another means not shown.

The authentication subprocess P2 execution unit 22′ is activated by the communication unit 21′, and based on the authentication execution request received from the communication unit 21′ and the confidential execution content received from the confidential content management unit 26, executes the authentication subprocess P2 and sends out the execution result to the authentication context generating unit 25′.

The authentication context generating unit 25′ has the function of generating the second authentication context by describing, according to a specified format, the authenticator generated by the authenticator generating unit 24, the content of execution other than the object (confidential execution content) of the second hash value in the authentication subprocess P2 execution unit 22′ and the second hash value received from the hash value generating unit 27, and the function of sending out the second authentication context to the communication unit 21′. The authenticator is generated by the authenticator generating unit 24 for the content of execution of the authentication subprocess P2 and the second hash value based on the confidential information 2 in the confidential information management unit 23.

The confidential content management unit 26 has the function of holding the confidential execution content and the function of sending out the confidential execution content to the communication unit 21′, the authentication subprocess P2 execution unit 22′ and the hash value generating unit 27 upon activation of the authentication subprocess P2 execution unit 22′.

The hash value generating unit 27 has the function of generating the second hash value (the first-stage hash value) intended for the confidential execution content upon receipt of the particular confidential execution content (the confidential execution content input also to the second-stage authentication subprocess P1 and hidden from the verification device 30) from the confidential content management unit 26, and the function of sending out the particular second hash value to the authentication context generating unit 25′.

The first entity device 10, as shown on the right side of FIG. 8, includes a hash value generating unit 17 in addition to the aforementioned configuration. Accordingly, the contents processed by the communication unit 11′, the authentication subprocess P1 execution unit 12′ and the authentication context generating unit 15′ are somewhat different.

The communication unit 11′ has the function of activating the authentication subprocess P1 execution unit 12′ upon receipt of the authentication execution request from the verification device 30 and the confidential execution content from the second entity device 20, the function of sending out the authentication execution request and the confidential execution content to the authentication subprocess P1 execution unit 12′ activated while at the same time sending out the confidential execution content to the hash value generating unit 17, and the function of transmitting the first authentication context received from the authentication context generating unit 15′ to the verification device 30.

The authentication subprocess P1 execution unit 12′ is activated by the communication unit 11′, and based on the authentication execution request and the confidential execution content received from the communication unit 11′, executes the authentication subprocess P1 and sends out the execution result to the authentication context generating unit 15′.

The authentication context generating unit 15′ has the function of generating the first authentication context by describing, according to a specified format, the authenticator generated by the authenticator generating unit 14, the content of execution of the authentication subprocess P1 execution unit 12′ and the first hash value received from the hash value generating unit 17, and the function of sending out the first authentication context to the communication unit 11′. The authenticator is generated by the authenticator generating unit 14 for the content of execution of the authentication subprocess P1 and the first hash value based on the confidential information 1 in the confidential information management unit 13.

The hash value generating unit 17 has the function of generating the first hash value (second-stage hash value) providing the hash value intended for the confidential execution content upon receipt of the particular confidential execution content from the communication unit 11′, and the function of sending out the first hash value to the authentication context generating unit 15′.

The verification device 30, as shown in FIG. 9, includes a hash value comparator 39 but not the parts 33 to 35 related to the challenge information described above. Accordingly, the contents processed by the context verification unit 36′ are somewhat different. Nevertheless, the parts 33 to 35 related to the challenge information may be included without being omitted. Specifically, the function of verifying the challenge information and the function of verifying the hash value according to this embodiment are not necessarily included in different configurations but in the same configuration.

The communication unit 31 has the function of transmitting the authentication execution request to the first and second entity devices 10, 20, the function of receiving the first and second authentication contexts individually from the first and second entity devices 10, 20, and the function of sending out each authentication context received to the context verification unit 36′.

The context verification unit 36′ has the function of sending out each authentication context to the authenticator verification unit 38, the function of receiving the authenticator verification result from the authenticator verification unit 38, the function of sending out the first hash value and the second hash value contained individually in each authentication context to the hash value comparator 39, the function of receiving the hash value comparative verification result from the hash value comparator 39, the function of verifying the legitimacy of each authentication context based on the authenticator verification result and the hash value comparative verification result, and the function of confirming the contents (execution environment, execution result, etc.) of the authentication subprocesses P1, P2 based on the data block information in each authentication context.

The hash value comparator 39 has the function of verifying by comparison that the second and first hash values received from the context verification unit 36′ are identical to each other, and the function of returning the hash value comparative verification result obtained to the context verification unit 36′.

Next, the operation of the authentication system configured as described above is explained.

First, in the verification device 30, the communication unit 31 transmits the authentication execution request to the first and second entity devices 10, 20.

The second entity device 20, upon receipt of the authentication execution request through the communication unit 21′, activates the authentication subprocess P2 execution unit 22′. Also, the confidential content management unit 26, upon activation of the authentication subprocess P2 execution unit 22′, sends out the confidential execution content to the communication unit 21′, the authentication subprocess P2 execution unit 22′ and the hash value generating unit 27. The communication unit 21′ transmits the received confidential execution content to the first entity device 10.

On the other hand, the authentication subprocess P2 execution unit 22′, once activated, executes the authentication subprocess P2 based on the authentication execution request received from the communication unit 21′ and the confidential execution content received from the confidential content management unit 26, and sends out the execution result to the authentication context generating unit 25′.

The execution result of the authentication subprocess P2 execution unit 22′ may be considered as the confidential execution content. The confidential execution content being the biometric information acquired by an external sensor is an example.

In this case, in response to the authentication execution request received from the communication unit 21′, the execution result of the authentication subprocess P2 execution unit 22′ is sent out to the confidential content management unit 22. The confidential content management unit 22 holds the execution result received from the authentication subprocess P22 execution unit 22′ as the confidential execution content, and transmits the particular confidential execution content to the communication unit 21′ and the hash value generating unit 27.

In the case where the confidential execution content is held beforehand in the confidential content management unit 26, the confidential content management unit 26 desirably sends out the confidential execution content including the confidential execution content held beforehand and the execution content received from the authentication subprocess P2 execution unit 22′ to the communication unit 21′ and the hash value generating unit 27. As an alternative, they may be transmitted separately from each other and combined on the part of the hash value generating unit 27.

Also, the hash value generating unit 27, upon receipt of the confidential execution content from the confidential content management unit 26, generates the second hash value providing the hash value intended for the particular confidential execution content and sends out the second hash value to the authentication context generating unit 25′.

The authentication context generating unit 25′ generates the second authentication context by describing, in accordance with a specified format, the authenticator generated by the authenticator generating unit 24, the execution content other than the confidential execution content in the authentication subprocess P2 execution unit 22′ and the second hash value received from the hash value generating unit 27, and sends out this second authentication context to the communication unit 21′.

The communication unit 21′ transmits the second authentication context to the verification device 30.

In the first entity device 10, on the other hand, the communication unit 11′, upon receipt of the authentication execution request from the verification device 30 and the confidential execution content from the second entity device 20, activates the authentication subprocess P1 execution unit 12′, and sends out the authentication execution request and the confidential execution content to the authentication subprocess P1 execution unit 12′ while at the same time sending out the confidential execution content to the hash value generating unit 17.

In the process, the verification device 30 may transmit the authentication execution request to an authentication execution control device not shown instead of to the first entity device 10 and the second entity device 20, and the authentication execution control device may transmit the authentication execution request to the first entity device 10 and the second entity device 20.

In this case, as long as a particular entity device to which the authentication execution request is to be transmitted is determined beforehand in the authentication execution control device, the verification device 30 may send the authentication execution request to the authentication execution control device without designating any entity device.

Also, the first authentication context and the second authentication context generated by the first entity device 10 and the second entity device 20, respectively, may be transmitted to the authentication execution control device and then collectively to the verification device 30 without being directly transmitted to the verification device 30.

The authentication subprocess P1 execution unit 12′, based on the authentication execution request and the confidential execution content received from the communication unit 11′, executes the authentication subprocess P1 and sends out the execution result to the authentication context generating unit 15′.

The hash value generating unit 17, upon receipt of the confidential execution content from the communication unit 11′, generates the first hash value providing the hash value for the particular confidential execution content, and sends out this first hash value to the authentication context generating unit 15′.

The authentication context generating unit 15′ generates the first authentication context by describing, according to a specified format, the authenticator generated by the authenticator generating unit 14, the execution content of the authentication subprocess P1 execution unit 12′ and the first hash value received from the hash value generating unit 17, and sends out the first authentication context to the communication unit 11′.

The communication unit 11′ transmits the first authentication context to the verification device 30.

In the verification device 30, the communication unit 31 receives the first and second authentication contexts individually and sends out each authentication context to the context verification unit 36′.

The context verification unit 36′ sends out each authentication context to the authenticator verification unit 38 and receives the authenticator verification result from the authenticator verification unit 38.

Also, the context verification unit 36′ sends out the first hash value and the second hash value contained individually in each authentication context to the hash value comparator 39. The hash value comparator 39 verifies by comparison that the first and second hash values are identical to each other, and returns the hash value comparative verification result obtained to the context verification unit 36′.

As a result, the context verification unit 36′ verifies the legitimacy of each authentication context based on the authenticator verification result and the hash value comparative verification result. Also, the context verification unit 36′ confirms the contents (execution environment, execution result, etc.) of the authentication subprocesses P1, P2 based on the information of the data block in each authentication context.

As described above, according to this embodiment, the verification device 30 verifies that the hash values contained in the authentication contexts Ac1, Ac2 are identical to each other thereby to confirm that is the confidential execution content of the first-stage authentication subprocess P1 and the confidential execution content of the second-stage authentication subprocess P2 are identical to each other. Thus, the security against the replacement attack against the confidential information can be improved. As a result, the “illegal replacement” of the biometric information in confirming the principal in biometrics, for example, can be prevented, which improves security.

Also, this embodiment, though configured of two entity devices including the first entity device 10 and the second entity device 20, may alternatively be configured of more entity devices. In this case, each entity device may have either the same configuration as the first entity device 10 and the second entity device 20 or the functions of both the first entity device 10 and the second entity device 20 at the same time. In such a case, one functional part can execute a plurality of the same functions.

### Third Embodiment

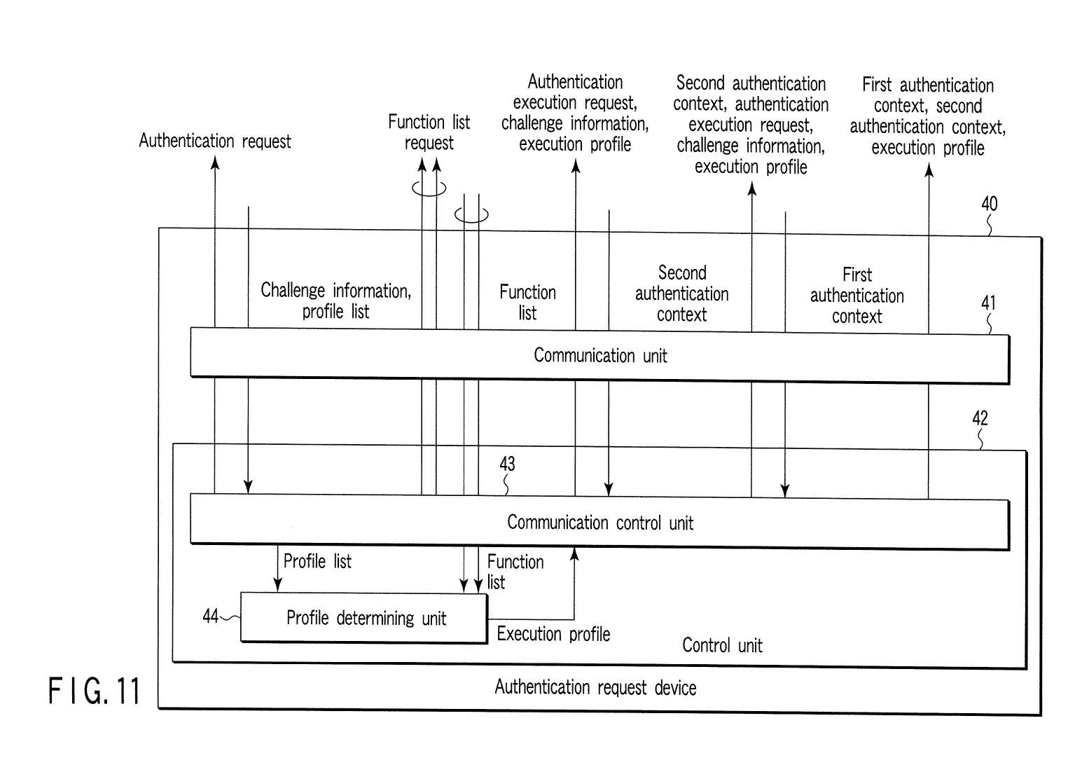

FIG. 10 is a schematic diagram showing the configuration of an authentication system according to a third embodiment of the invention. This embodiment represents an example of the authentication system using biometrics authentication.

This embodiment represents an example of the authentication system in which the execution result of the authentication subprocess P1 is obtained based on the execution result of the authentication subprocess P2.

This authentication system includes an authentication request device 40 between the first entity device 10, the second entity device 20 and the verification device 30. Specifically, the challenge information and a profile list summarizing the profiles defining the execution environment acceptable by the verification device 30 are transmitted collectively to the authentication request device 40 by the verification device 30 before starting the authentication. The authentication request device 40 determines the execution profile in such a manner as to meet the requirements of both the profile list and the function lists of the devices 10, 20, and according to this execution profile, causes the devices 10, 20 to execute the authentication. The authentication request device 40 returns the first and second authentication contexts and the execution profile thus obtained to the verification device 30. Specifically, this authentication system, with the configuration having the authentication request device 40, can hide the function list of the devices 10, 20 from the verification device 30.

The authentication request device 40, as shown in FIG. 11, includes a communication unit 41 and a control unit 42. The control unit 42 includes a communication control unit 43 and a profile determining unit 44.

The communication unit 41 is a communication interface between the devices 10, 20, 30 and the communication control unit 43. In the explanation that follows, the description of the interposition of the communication unit 41 for communication between the devices 10, 20, 30 and the communication control unit 43 is omitted for simplification.

The communication control unit 43 has the function of transmitting the authentication request to the verification device 30, the function of receiving the challenge information and the profile list from the verification device 30, the function of sending out the profile list to the profile determining unit 44, the function of transmitting the function list request individually to the first and second entity devices 10, 20, the function of receiving the function list individually from the entity devices 10, 20, the function of sending out the function list to the profile determining unit 44, the function of transmitting the authentication execution request and the challenge information received from the aforementioned verification device 30 to the second entity device 20 together with the execution profile received from the profile determining unit 44, the function of receiving the second authentication context from the second entity device 20, the function of transmitting the authentication execution request, the aforementioned challenge information and the execution profile to the first entity device 10 together with the second authentication context, the function of receiving the first authentication context from the first entity device 10, and the function of transmitting the first and second authentication contexts and the execution profile to the verification device 30.

Incidentally, the function list request may be transmitted each time the authentication process is executed or at the time of initialization of the authentication request device 40. In the case where the function list request is transmitted at the time of initialization, the function list obtained is held in the authentication request device 40.

The profile determining unit 44 has the function of determining the execution profile used for authentication in such a manner as to meet the requirements of both the profile list and the function list received from the communication control unit 43 and the function of sending out the particular execution profile to the communication control unit 43.

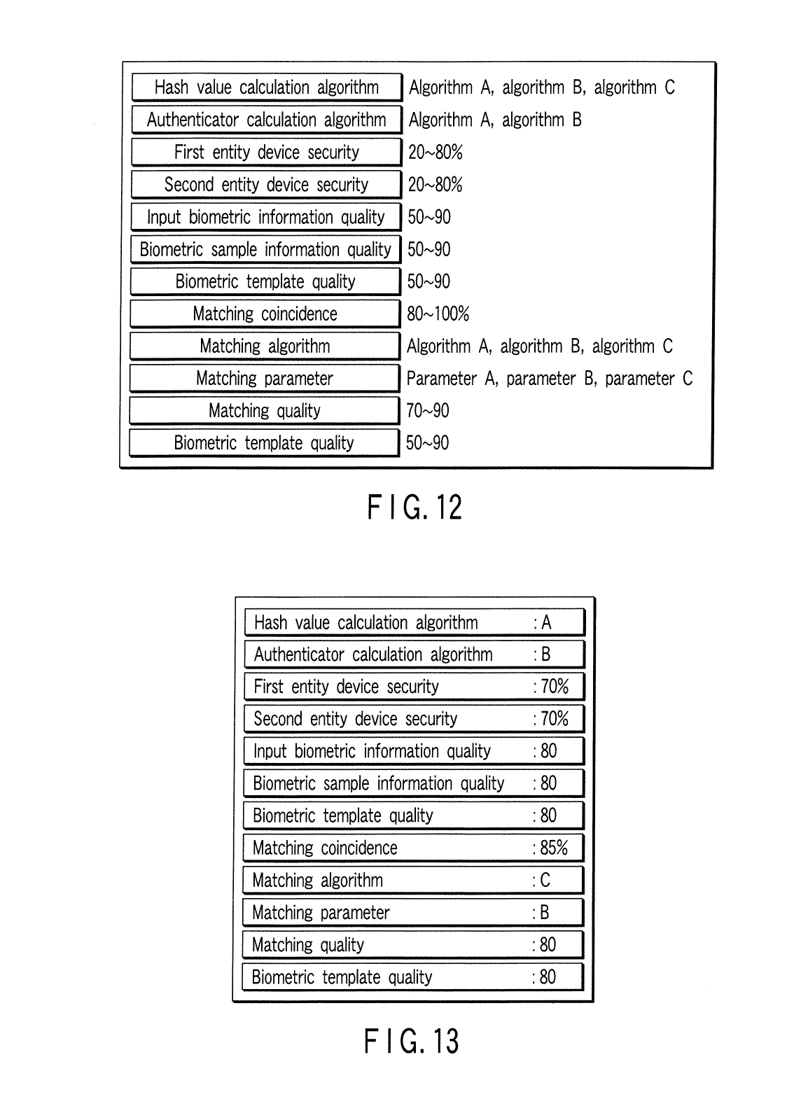

The profile list contains the description (information) of the information of the profile (execution environment) of the entity devices 10, 20 acceptable by the verification device 30, and as shown in FIG. 12, for example, has listed therein candidates of the hash value calculation algorithm and candidates of the authenticator calculation algorithm. Incidentally, the profile list is not necessarily in the form of a list. The profile list may be either the information described in the form (of a sentence) enumerating the information of acceptable profiles (without changing the line) or the information described in the form of a table (a list in the broad sense of the word). Specifically, the profile list is defined as information, in whatever form of description, containing the description of the information of the profile acceptable by the verification device 30.

The function list specifies the function (execution environment) for executing the authentication subprocess in the entity devices 10, 20.

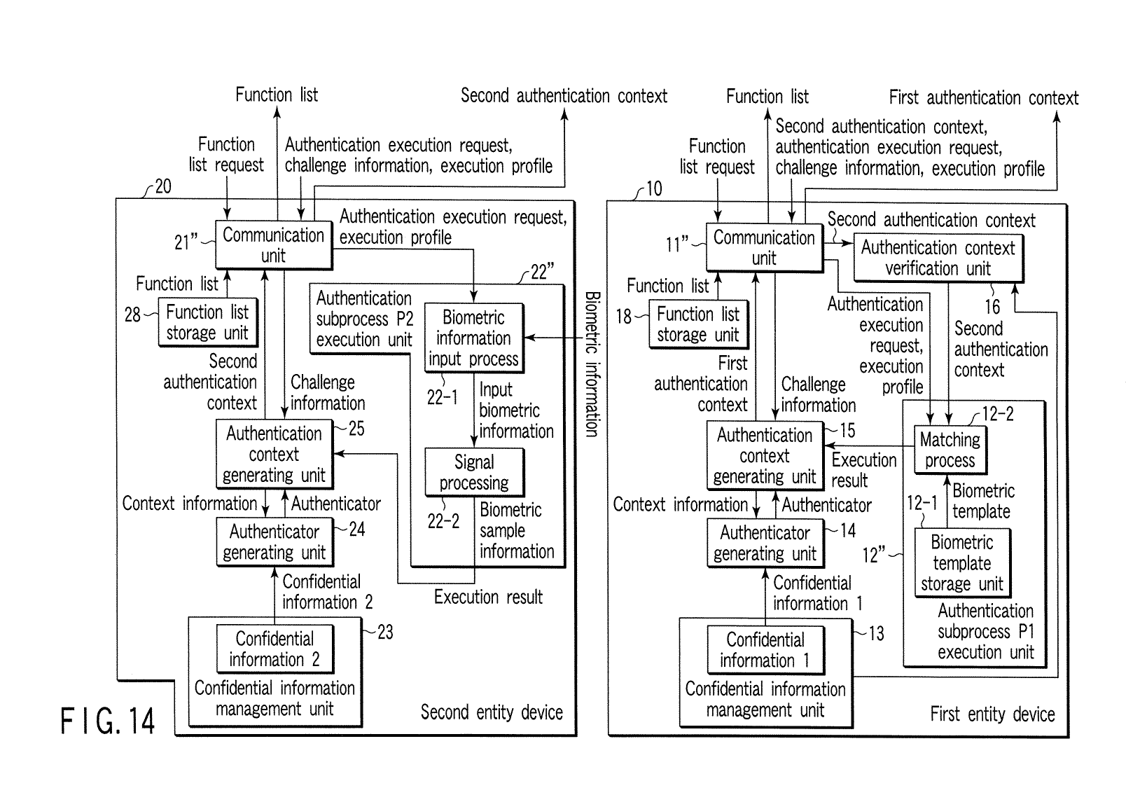

The execution profile, which is determined (or selected) in such a manner as to meet the requirements of the profile list and each function list, is executed at the time of authentication and as shown in FIG. 13, contains the description of the hash value calculation algorithm and the authenticator calculation algorithm.

The first and second entity devices 10, 20, to which the authentication context verification unit 16 is added in the aforementioned configuration as shown in FIG. 14, include function list storage units 18, 28. Accordingly, each communication unit 11″, 21″ has the function of returning the function list in the function list storage units 18, 28 in response to the function list request received from the authentication request device 40 and returning the authentication context in respect of the authentication execution request, the challenge information and the execution profile. Incidentally, the challenge information, which can be omitted from the viewpoint of hiding the function list, is included in this example.

Also, the authentication subprocess P2 execution unit 22″ includes a biometric information input processing function 22-1 and a signal processing function 22-2. The authentication subprocess P1 execution unit 12″ includes a biometric template storage unit 12-1 and a matching process function 12-2.

In this case, the authentication subprocess P2 execution unit 22″, upon receipt of the authentication execution request and the execution profile from the communication unit 21″, executes the biometric information input processing function 22-1 and the signal processing function 22-2 based on the execution profile, and sends out the execution result to the authentication context generating unit 25.

The biometric information input processing function 22-1 generates the input biometric information based on the biometric information input and sends out this input biometric information to the signal processing function 22-2. The signal processing function 22-2 generates the biometric sample information based on the input biometric information received from the biometric information input processing function 22-1, and sends out the execution result having this biometric sample information to the authentication context generating unit 25.

The authentication subprocess P1 execution unit 12″, upon receipt of the authentication execution request and the execution profile from the communication unit 11″ and the second authentication context from the authentication context verification unit 16, executes the matching process function 12-2 with reference to the biometric template storage unit 12-1 based on the execution profile and the second authentication context, and sends out the execution result to the authentication context generating unit 15.

The biometric template storage unit 12-1 is a memory for storing the biometric template in advance and can be accessed from the matching process function 12-2.

The matching process function 12-2 executes the matching process for matching the biometric template in the biometric template storage unit 12-1 with the biometric sample information in the second authentication context, and sends out the execution result indicating the matching result to the authentication context generating unit 15.

The authentication context verification unit 16 verifies the second authentication context received from the communication unit 11″ based on the confidential information 1 in the confidential information management unit 10, and whenever the verification result is legitimate, sends out the second authentication context to the authentication subprocess P1 execution unit 12″.

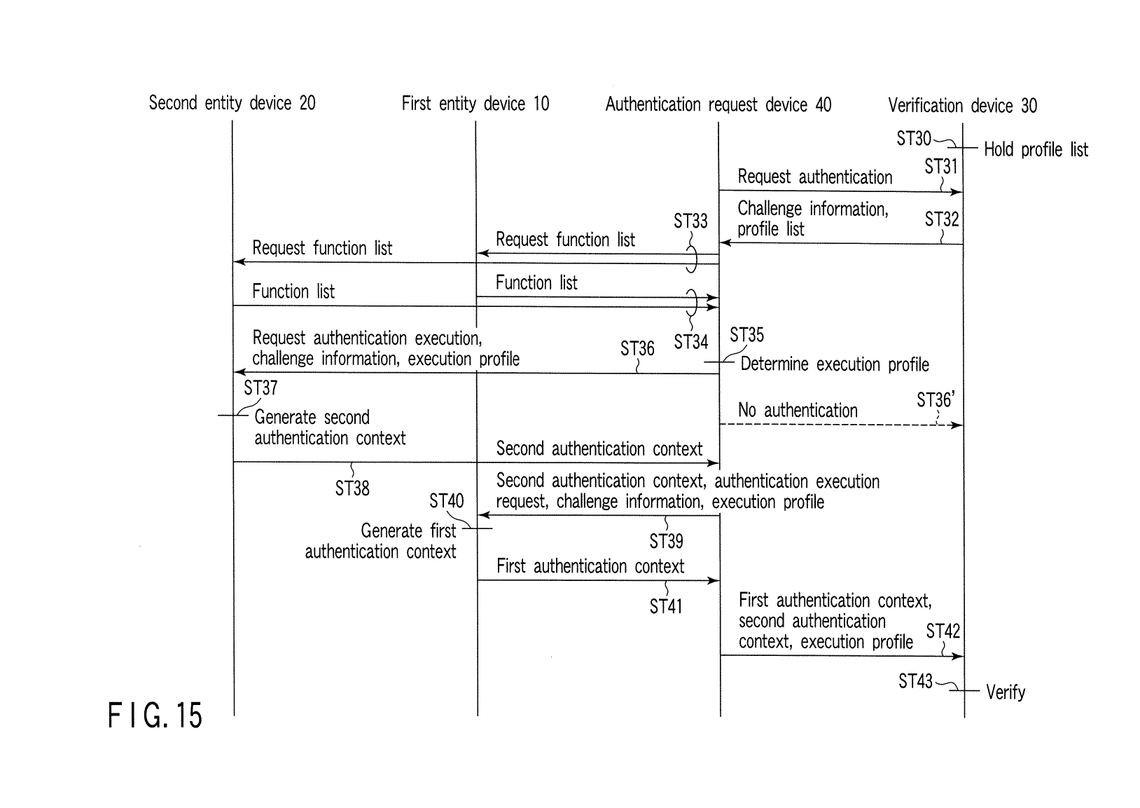

Next, the operation of the authentication system having this configuration is explained with reference to the sequence diagram of FIG. 15. This explanation concerns a case in which the authentication subprocess P2 execution unit 22 of the second entity device 20 collects the biological data and processes the signals while the authentication subprocess P1 execution unit 12 of the first entity device 10 executes the process of holding and matching the biometric template.

The verification device 30 holds a profile list having profiles acceptable to the component data of the first and second authentication contexts (ST30).

The authentication request device transmits the authentication request for biological authentication to the verification device 30 (ST31).

The verification device 30, upon receipt of the authentication request, transmits the challenge information and the profile list to the authentication request device 40 (ST32).

The authentication request device 40 receives the challenge information and the profile list and requests the function list individually from the first and second entity devices 10, 20 (ST33).

The first and second entity devices 10, 20 transmit the function lists read from the function list storage units 18, 28, respectively, to the authentication request device 40 (ST34).

In the authentication request device 40, the communication control unit 43 sends out each function list received from the entity devices 10, 20 and the profile list received from the verification device 30 to the profile determining unit 44.

The profile determining unit 44 compares each function list with the profile list, determines an execution profile in such a manner as to meet the requirements of the three lists (ST35), and sends out the execution profile to the communication control unit 43.

The authentication request device 40 transmits the authentication execution request, the challenge information and the execution profile to the second entity device 20 through the communication control unit 43 (ST36). Incidentally, in the case where the execution profile cannot be determined, the authentication request device 40 returns the message indicating the impossibility of authentication to the verification device (ST36′).

The second entity device 20, upon receipt of the authentication execution request, the challenge information and the execution profile, executes the authentication subprocess P2 (biometric information input process and the signal processing). At the same time, the authentication subprocess P2 execution unit 12″ generates the biometric sample information in accordance with the execution profile and sends out the execution result including the biometric sample information to the authentication context generating unit 15.

The authentication context generating unit 15 generates the authenticator through the authenticator generating unit 14 in accordance with the execution profile, and generates the second authentication context including the particular authenticator, the challenge information and the execution result (ST37).

The second entity device 20 transmits the second authentication context thus obtained to the authentication request device 40 (ST38).

The authentication request device 40 transmits the second authentication context, the authentication execution request, the challenge information and the execution profile to the first entity device 10 (ST39).

In the first entity device 10, the authentication context verification unit 16 verifies the completeness of the second authentication context. After that, the authentication subprocess P1 execution unit 12″ executes the matching process for matching the biometric sample information in the second authentication context with the biometric template in the reference information storage unit 12-1 in accordance with the execution profile, and sends out the execution result to the authentication context generating unit 15. The authentication context generating unit 15 generates the authenticator through the authenticator generating unit 14 in accordance with the execution profile, and generates the first authentication context including the particular authenticator, the challenge information and the execution result (ST40).

The first entity device 10 transmits the first authentication context to the authentication request device 40 (ST41).

The authentication request device 40 transmits the first and second authentication contexts and the execution profile to the verification device 30 (ST42).

The verification device 30 verifies each authentication context thus received (ST43).

Specifically, the verification device 30 verifies the completeness of each authentication context based on the authenticator in each authentication context. In addition, the verification device 30 may be so configured as to confirm that the authentication process has been executed without altering each piece of biometric information by confirming the authenticator of the biometric sample information and the authenticator of the biometric template. In this case, each piece of biometric information and the authenticator thereof may be included in the authentication contexts by the respective entity devices 10, 20.

Also, the verification device 30 confirms that the challenge information in each authentication context coincides with the value transmitted in step ST32, and thus confirms that there is no repetitive attack.

Finally, the verification device 30 compares the information contained in the authentication contexts, the execution profile and the profile list and then determines the advisability of the final authentication. In this way, the verification device 30 ends the verification process of step ST43.

In the process, the contents of the execution profile may not be left without being compared. This is by reason of the fact that the contents of the execution profile are contained also in the authentication context and therefore the effects of the invention remain unchanged by the non-comparison.

As described above, according to this embodiment, the authentication request device 40 determines the execution profile indicating the execution environment of the authentication entity devices 10, 20 in such a manner as to meet the requirements of both the profile list indicating the execution environment acceptable by the verification device 30 and the function lists of the entity devices 10, 20. In this way, the various execution environments of the entity devices 10, 20 not related to the execution of the authentication can be hidden from the verification device 30, and therefore, the privacy of the requester on the part of each authentication entity device 10, 20 can be protected.

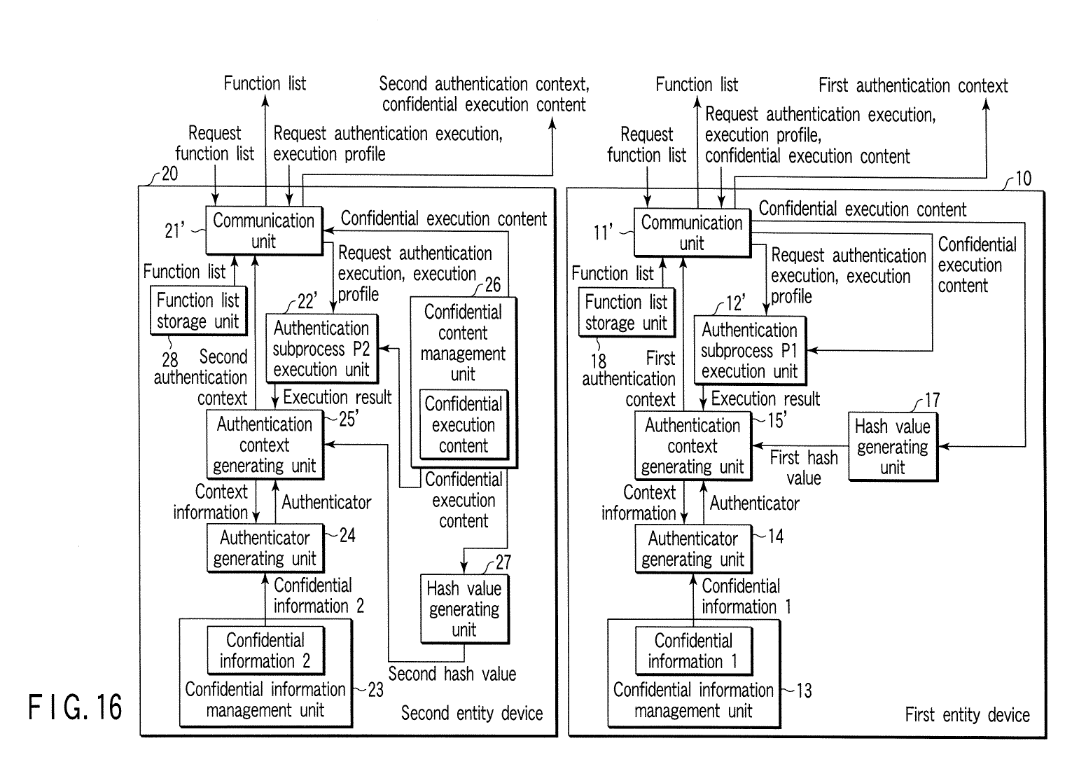

Also, this embodiment is applicable not only to the first embodiment using the challenge information but also, as shown in FIGS. 10, 16, to the second embodiment using the hash value with equal effect. Incidentally, according to the modification shown in FIG. 16, the contents of confidential execution are transmitted to the first entity device 10 from the second entity device 20 through the authentication request device 40.

### Fourth Embodiment

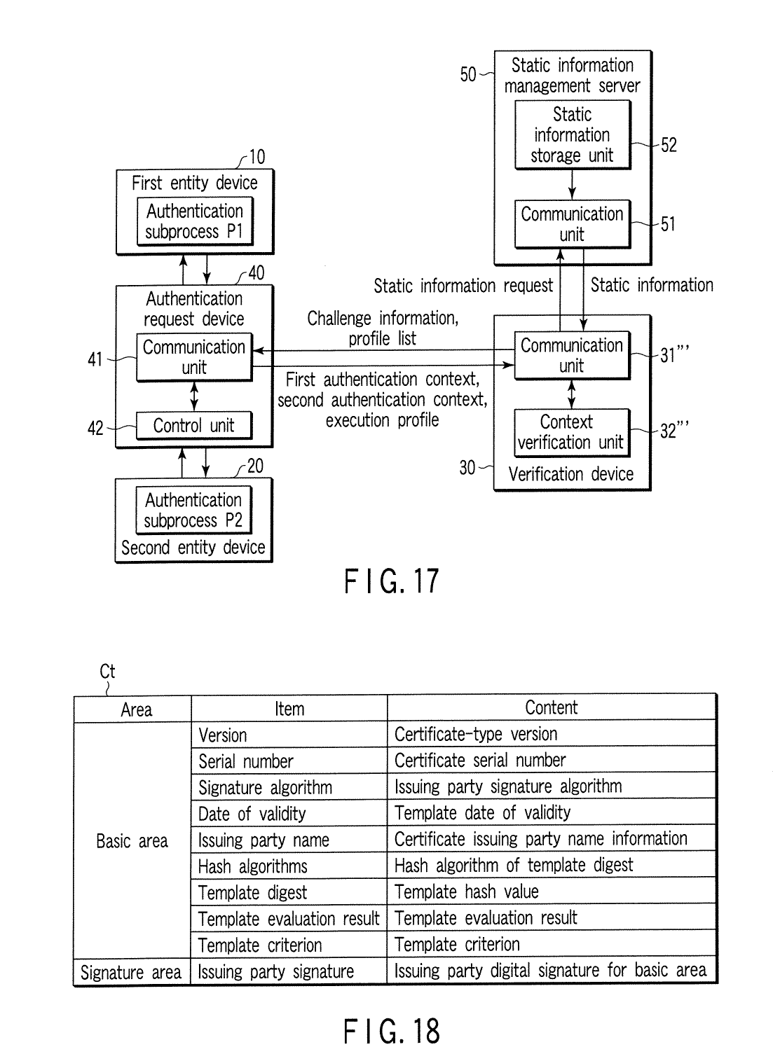

FIG. 17 is a schematic diagram showing the configuration of the authentication system according to a fourth embodiment of the invention.

In the first to third embodiments, the verification of the authentication context by the verification device 30 may require the access to the static information (information remaining unchanged each time of authentication) in, for example, the data blocks d1, d2. From the viewpoint of communication traffic, however, a low efficiency results if the static information is transmitted by being described in the authentication context each time of authentication.

According to this embodiment, typically as in the example applied to the third embodiment, the communication traffic is reduced by describing the link destination information (identification information such as URL (uniform resource locator), URN (uniform resource name) or URI (uniform resource identifier)) in the authentication context without describing the static information in the authentication context. Naturally, the link destination information contains the description of a link destination smaller in data amount than the static information.

In the case where the static information constitutes the information on the entity devices 10, 20, for example, the link destination includes a static information management server 50 managed by the maker of the entity devices 10, 20 or a fair third party organization.

The static information management server 50 includes a communication unit 51 for returning the static information in the static information storage unit 52 to the requester in response to the static information request received from an external source and a static information storage unit 52 for storing the static information in a manner readable from the communication unit 51.

In the case where the static information is the information on the biometric template, the server of a biometric information register or a public evaluation organization, though not shown, may constitute the link destination.

The link destination is not limited to a server, but the information whereby a certificate can be issued for static information by a reliable organization may constitute the link information. In the case of the template evaluation information, for example, the information such as the issuing party name and the serial number whereby the template certificate issued by a registration organization for the hash value of the template and the evaluation information may be used as the link destination information. An example of such a template certificate Ct is shown in FIG. 18.

This template certificate Ct is configured of a basic area and a signature area. The basic area includes such items (and contents) as the version (the version of the certificate form), the serial number (the serial number of the certificate), the signature algorithm (the signature algorithm of the signature of the issuing party), the expiry date (the expiry date of the template), the name of the issuing party (the issuing party name information of the certificate), the hash algorithm (the hash algorithm of the template digest), the template digest (the hash value of the template), the template evaluation result (the evaluation result of the template) and the criterion for template evaluation (the evaluation criterion for the template).

The signature area includes such an item (and content) as the signature of the issuing party (the digital signature of the issuing party for the basic area).

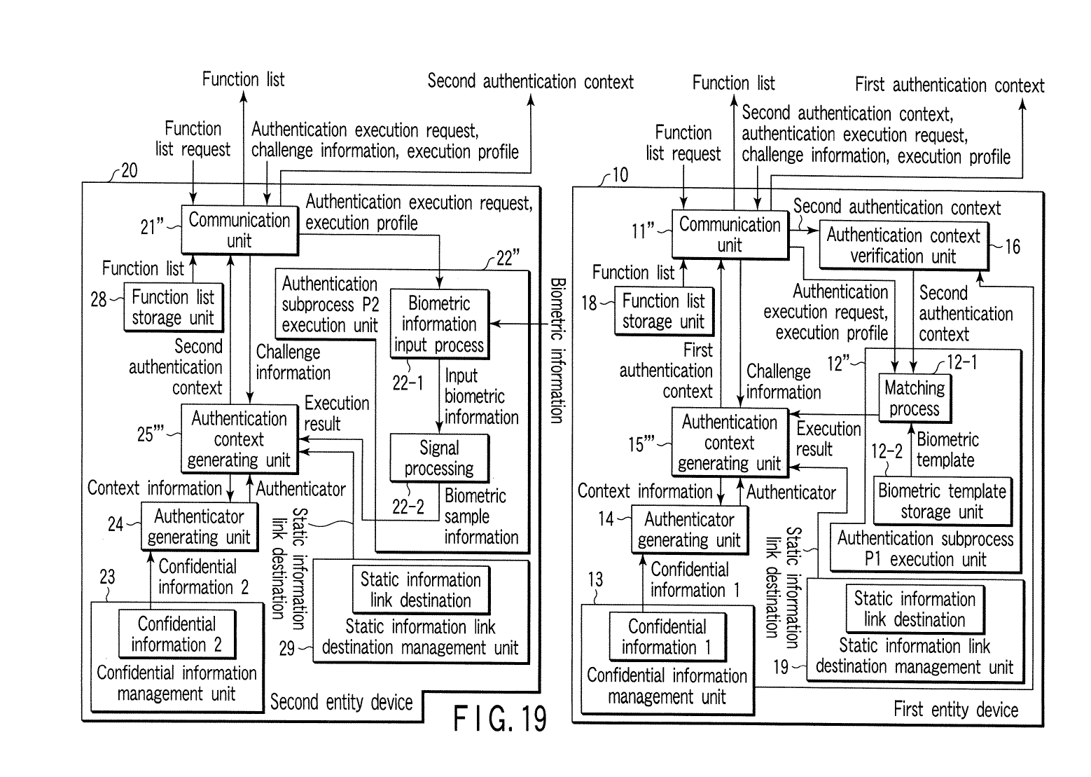

Next, the first and second entity devices 10, 20, as shown in FIG. 19, include static information link destination management units 19, 29 for storing the link destination information of the static information in addition to the aforementioned configuration. Accordingly, the authentication context generating units 15″, 25″ generate the first or second authentication context including the link destination information in place of the static information, in addition to the execution result of the authentication subprocess P1, P2 execution units 12″, 22″.

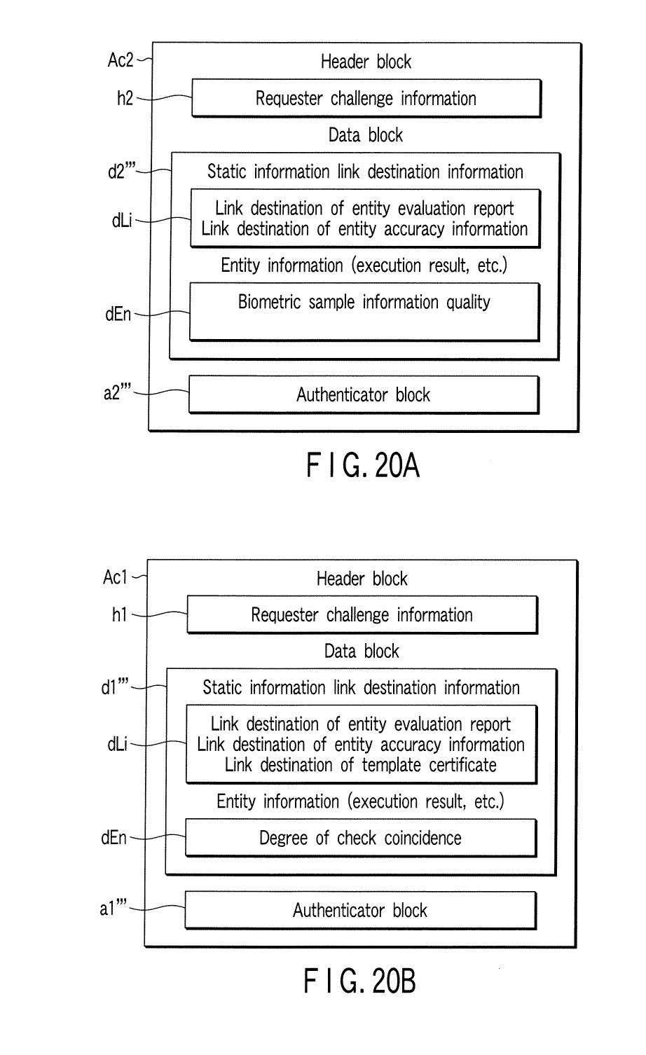

An example of the first and second authentication contexts Ac1, Ac2 is shown in FIGS. 20A and 20B. In this example, link destination information dLi of the static information and entity information dEn are stored in the data blocks d1″, d2″, respectively. The link destination information dLi includes the link destination of the static information such as the entity evaluation report, the entity accuracy information and the template certificate used for the matching process. Incidentally, differing information for a different authentication is stored in the entity information (execution result, etc.). The entity information dEn includes the quality of the biometric sample information and the degree of coincidence of the matching process.

Next, the operation of the authentication system configured as described above is explained.

Assume that the verification device 30, as in the third embodiment, has received the first and second authentication contexts and the execution profile from the authentication request device 40.

The verification device 30, as described above, verifies each authentication context and transmits the static information request to the static information management server 50, for example, based on the static information link destination information in each authentication context as required.

The static information management server 50, upon receipt of the static information request through the communication unit 51, returns the corresponding static information in the static information storage unit 52 to the verification device 30 from the communication unit 51 based on the static information request.

The verification device 30, based on the static information thus received, continues to verify each authentication context and finally determines the advisability of the authentication. Incidentally, the verification device 30 may hold, in a cache memory (not shown), the static information received in the past to improve the access rate to the link destination.

As described above, according to this embodiment, the entity devices 10, 20 generate the authentication contexts Ac1, Ac2 in such a manner as to contain the link destination information for acquiring the static information smaller in data amount than the static information indicating the same content for each authentication session, and therefore, the size of the authentication context is reduced. As a result, the communication traffic between the authentication request device 40 and the verification device 30 can be reduced, which improves communication efficiency of the authentication context.

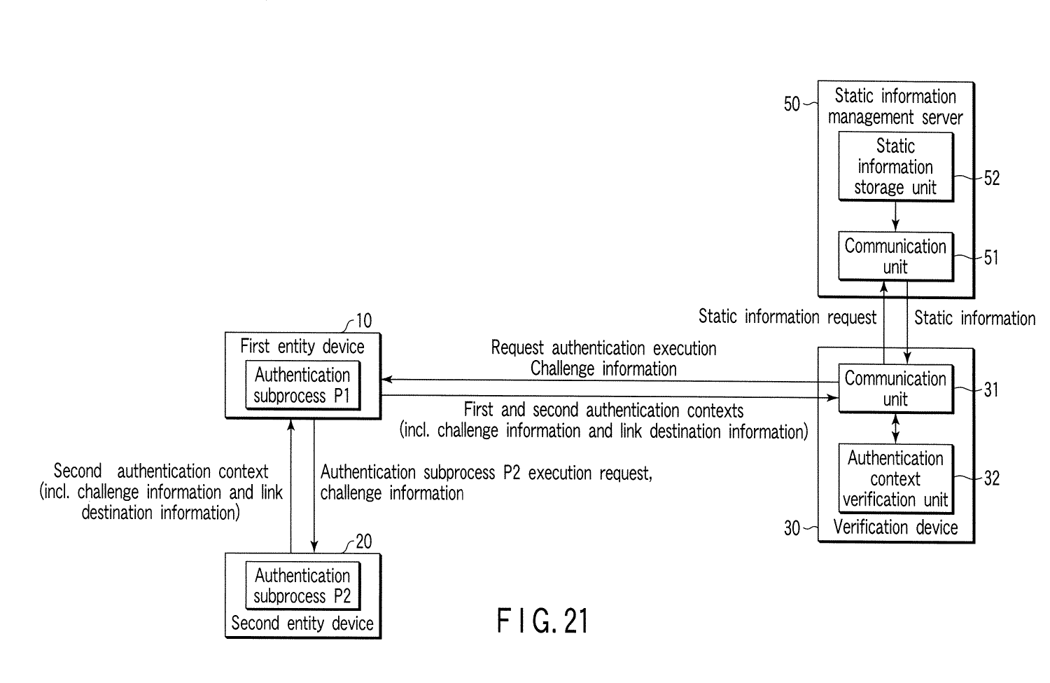

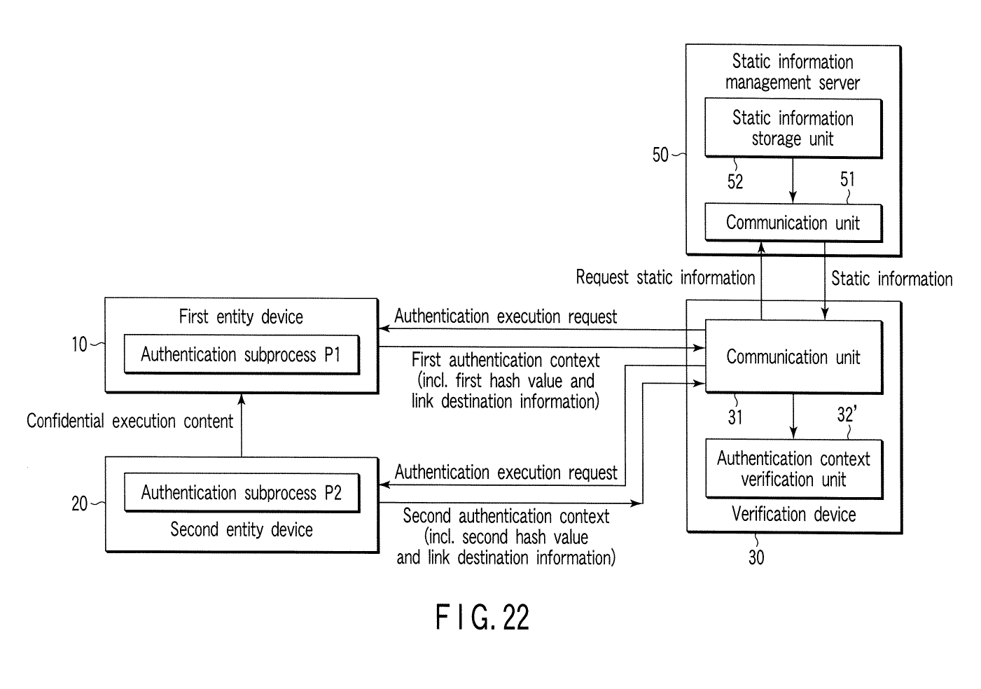

Incidentally, this embodiment is applicable not only to the third embodiment using the authentication request device 40 but also to the first or second embodiment lacking the authentication request device 40 with equal effects, as shown in FIGS. 21 and 22. Also in this modification, the entity devices 10, 20 have the static information link destination management units 19, 29 and, naturally, the authentication context is generated by the authentication context generating units 15, 25 in such a manner as to include the link destination information in place of the static information.

The method exhibited in each above-mentioned embodiment can be distributed as a computer executable program by storing into a storage medium such as a magnetic disk (floppy [trade mark] disk, hard disk, etc.), an optical disk (CD-ROM, DVD, etc.), a magnet-optical disk (MO) and a semiconductor memory.

Regardless of type of storage format, any storage medium capable of storing the program and being read by the computer is usable as the storage medium for this program.

An operating system (OS) or middleware (MW) such as a database management software and a network software running on the computer, based on the instruction installed in the computer from the storage medium, may executes a part of each processing to achieve each above-described embodiment.

The storage medium for the invention is not limited to a medium independent from the computer, and includes the storage medium with a program transmitted via a LAN, the Internet, etc., downloaded and stored or temporarily stored thereon.

The number of the storage medium for the invention is not limited only one, and the storage medium of the invention includes the case that processing in each embodiment is respectively executed by means of a plurality of media, and any structure of the medium is acceptable.

The computer in the invention executes each processing in each above mentioned embodiment, based on the program stored in the storage medium. Any configuration of the computer such as a device composed of a single personal computer, etc., and a system composed of a plurality of devices network-connected therein are available.

The computer in the invention is not limited to a personal computer, and includes computing processing device, a micro-computer, etc., included in information processing equipment and generically means equipment and a device capable of achieving the functions of the invention.

The invention in its broader aspects is not limited to the specific details and representative embodiments shown and described herein, and can be embodied in their implementation phases by modifying constituent components without departing from the spirit or scope of the general inventive concept of the invention. A variety of modifications of the invention may be made by appropriate combinations of a plurality of constituent components shown in each foregoing embodiment. For example, some constituent components may be omitted from the whole of the constituent components shown in each embodiment. Furthermore, the constituent components over different embodiments can be appropriately combined.

The method exhibited in each above-mentioned embodiment can be expressed as shown in following item 1 to 13.

1. An authentication system comprising a plurality of authentication entity devices which individually execute authentication subprocesses making up an authentication process and a verification device which verifies the authentication process executed by the entity devices, wherein the authentication entity devices each include: a challenge information receiving module configured to receive a challenge information generated by the verification device; a confidential information storage module configured to store a confidential information for the verification; an authenticator generating module configured to generate an authenticator for the contents of execution of the authentication subprocesses and the challenge information based on the confidential information; an authentication context generating module configured to generate an authentication context describing the authenticator, the contents of execution and the challenge information in accordance with a specified format; and an authentication context transmitting module configured to transmit the authentication context, and the verification device includes: a verification information storage module configured to store an authenticator verification information corresponding to the confidential information; a challenge generating module configured to generate the challenge information; a challenge storage module configured to store the challenge information; a challenge information transmitting module configured to transmit the challenge information; an authentication context receiving module configured to receive each authentication context generated by the authentication entity devices; a challenge verification module configured to verify whether the challenge information identical to the challenge information in the challenge storage module is described for each of the authentication contexts received; an authenticator verification module configured to verify the authenticator for each authentication context based on the authenticator verification information; and an authentication context verification module configured to verify the legitimacy of each authentication context based on the verification result of each of the verification module.

2. An authentication system comprising a plurality of authentication entity devices which individually execute authentication subprocesses making up an authentication process and a verification device which verifies the authentication processes executed by the entity devices, wherein the authentication entity devices include at least one first-stage authentication entity device and at least one second-stage authentication entity device the first-stage authentication entity device includes: a first-stage hash value generating module configured to generate a first-stage hash value for a confidential execution content which is included in the execution content of the authentication subprocesses and which is input to a second-stage authentication subprocess and hidden from the verification device; a first-stage confidential information storage module configured to store a confidential information for the verification; a first-stage authenticator generating module configured to generate an authenticator for the contents of execution of the authentication subprocess and the first-stage hash value based on the confidential information; a first-stage authentication context generating module configured to generate an authentication context describing, in accordance with a specified format, the authenticator, the execution content other than for the first-stage hash value and the first-stage hash value; and a first-stage transmitting module configured to transmit the authentication context and the confidential execution content, the second-stage authentication entity device includes: a confidential execution content receiving module configured to receive the confidential execution content transmitted; a second-stage hash value generating module configured to generate a second-stage hash value for the confidential execution content received; a second-stage confidential information storage module configured to store the confidential information for the verification; a second-stage authenticator generating module configured to generate an authenticator for the execution content of the authentication subprocess and the second-stage hash value based on the confidential information; a second-stage authentication context generating module configured to generate an authentication context describing the authenticator, the execution content and the second-stage hash value in accordance with a specified format; and a second-stage transmitting module configured to transmit the authentication context, and the verification device includes: a verification information storage module configured to store an authenticator verification information corresponding to the confidential information; an authentication context receiving module configured to receive the authentication contexts generated by the authentication entity devices; a hash value comparative verification module configured to verify by comparison that the first-stage hash value and the second-stage hash value contained in the authentication context received are identical to each other; an authenticator verification module configured to verify the authenticator for each of the authentication contexts based on the authenticator verification information; and an authentication context verification module configured to verify the legitimacy of the authentication contexts based on the verification result by the verification module.

3. The authentication system according to item 1, comprising an authentication request device which relays the communication between the verification device and the authentication entity devices, wherein the verification device includes: a profile list generating module configured to generate the profile list specifying an execution environment acceptable for execution of the authentication subprocesses; and a list transmitting module configured to transmit the profile list to the authentication request device, the authentication request device includes: a profile list receiving module configured to receive the profile list; a function list receiving module configured to receive, for each authentication entity device, a function list specifying the functions of executing the authentication subprocesses; a profile determining module configured to determine an execution profile in such a manner as to meet the requirements of both the profile list and the function list; and an execution profile transmitting module configured to transmit the execution profile to the authentication entity devices, and the authentication entity devices each include: an execution profile receiving module configured to receive the execution profile from the authentication request device; and an authentication subprocess execution module configured to execute the authentication subprocesses based on the execution profile.

4. The authentication system according to item 1, wherein the authentication entity devices each include link destination information storage module configured to storing link destination information which is smaller in data amount than static information having the same content for each authentication session and which is adapted to acquire the static information, the authentication context generating module generates the authentication context in such a manner as to include the link destination information in place of the static information, and the verification device includes: a module configured to acquire the static information based on the link destination information in the authentication content received; and a verification module configured to verify the authentication process based on the static information and the execution content in the authentication context.

5. A program stored in a computer-readable storage medium for use in a computer of each of authentication entity devices which are communicable with a verification device to verify an authentication process and which individually execute authentication subprocesses making up the authentication process, the program comprising: receiving program code for receiving challenge information generated by the verification device; authenticator generating program code for generating an authenticator for execution contents of the authentication subprocesses and the challenge information based on the confidential information-stored in the each authentication entity device; authentication context generating program code for generating an authentication context describing the authenticator, the execution contents and the challenge information in accordance with a specified format; and authentication context transmitting program code for transmitting the authentication context to the verification device, and the authentication context is such that the verification device verifies whether the challenge information identical to the challenge information generated by the verification device is described or not, and based on authenticator verification information corresponding to the confidential information, the verification device verifies the authenticator thereby to verify the legitimacy based on the verification result.

6. A program stored in a computer-readable storage medium for use in a computer of a verification device communicable with a plurality of authentication entity devices which individually execute authentication subprocesses making up an authentication process and adapted to verify the authentication process executed by the authentication entity devices, the program comprising: challenge generating program code for generating the challenge information; challenge information transmitting program code for transmitting the challenge information; authentication context receiving program code for receiving an authentication context transmitted from the authentication entity devices after the authentication entity devices generate an authenticator for execution contents of the authentication subprocesses and the challenge information based on the confidential information, and an authentication context is generated by describing the authenticator, the execution contents and the challenge information in accordance with a specified format; challenge verification program code for verifying whether the challenge information identical to the challenge information in the challenge storage device is described or not for each authentication context received; authenticator verification program code for verifying the authenticator for each authentication context based on authenticator verification information stored in the verification device, the authenticator verification information corresponding to confidential information stored in the authentication entity devices; and authentication context verification program code for verifying the legitimacy of the authentication context based on the verification result of the verification program code.

7. A program stored in a computer-readable storage medium for use in a computer of at least one first-stage entity device communicable with a verification device to verify an authentication process and also communicable with at least one second-stage authentication entity device among a plurality of authentication entity devices which individually execute authentication subprocesses making up the authentication process, the program comprising: first-stage hash value generating program code for generating a first-stage hash value for a confidential execution content, among the execution contents of the authentication subprocesses, input to a second-stage authentication subprocess and hidden from the verification device; first-stage authenticator generating program code for generating an authenticator for the execution contents of the authentication subprocesses and the first-stage hash value based on the confidential information stored in the first-stage entity device; first-stage authentication context generating program code for generating a first-stage authentication context describing the authenticator, the execution content for other than the first-stage hash value and the first-stage hash value in accordance with a specified format; and first-stage transmitting program code for transmitting the authentication context and the confidential execution content, the confidential execution content is received by the second-stage authentication entity device and converted into a second-stage hash value for the particular confidential execution content, the second-stage hash value is converted by the second-stage authentication entity device into the authenticator for the execution content of the authentication subprocess and the second-stage hash value based on the confidential information on the one hand and described in the second-stage authentication context together with the authenticator and the execution content in accordance with a specified format and transmitted together with the second-stage authentication context on the other hand, and the verification device receives the authentication contexts, verifies by comparison that the first-stage hash value and the second-stage hash value contained in the authentication context are identical to each other, verifies the authenticator for each authentication context based on the authenticator verification information corresponding to the confidential information, and verifies the legitimacy based on the verification result.

8. A program stored in a computer-readable storage medium for use in a computer of at least one second-stage entity device communicable with a verification device to verify an authentication process and also communicable with at least one first-stage authentication entity device among a plurality of authentication entity devices which individually execute authentication subprocesses making up the authentication process, the program comprising: confidential execution content receiving program code for receiving, from the first-stage authentication entity device, a confidential execution content included in the execution contents of the authentication subprocesses, which is input to the second-stage authentication subprocess and hidden from the verification device; second-stage hash value generating program code for generating a second-stage hash value for the confidential execution content received; second-stage authenticator generating program code for generating an authenticator for the execution contents of the authentication subprocess and the second-stage hash value based on the confidential information stored in the second-stage entity device; second-stage authentication context generating program code for generating an authentication context describing the authenticator, the execution content and the second-stage hash value in accordance with a specified format; and second-stage transmitting program code for transmitting the authentication context, the confidential execution content is converted into a first-stage hash value for the particular confidential execution content by the first-stage authentication entity device before being transmitted from the first-stage authentication entity device, the first-stage hash value is converted into an authenticator for the execution content of the authentication subprocess and the first-stage hash value based on the confidential information by the first-stage authentication entity device while at the same time being described in the first-stage authentication context in accordance with a specified format together with the authenticator and the execution content and transmitted together with the first-stage authentication context, and the verification device receives the authentication contexts, verifies by comparison that the first-stage hash value and the second-stage hash value contained in the authentication context are identical to each other, verifies the authenticator for each authentication context based on the authenticator verification information corresponding to the confidential information, and verifies the legitimacy based on the verification result.

9. A program stored in a computer-readable storage medium for use in a computer of a verification device communicable with a plurality of authentication entity devices which individually execute authentication subprocesses making up an authentication process and adapted to verify the authentication processes executed by the authentication entity devices, the program comprising: first authentication context receiving program code for receiving a first-stage authentication context transmitted from the first-stage authentication entity device after a first-stage hash value for the confidential execution content included in the execution contents of the authentication subprocesses, which is input to the second-stage authentication subprocess and hidden from the verification device, is generated by at least one of the first-stage authentication entity devices, an authenticator for the execution content of the authentication subprocess and the first-stage hash value is generated based on the confidential information, and the first-stage authentication context is generated by describing the authenticator, the execution content for other than the first-stage hash value and the first-stage hash value in accordance with a specified format; second authentication context receiving program code for receiving the second-stage authentication context transmitted from the second-stage authentication entity device after the confidential execution content transmitted from the first-stage authentication entity device is received by at least one of the second-stage authentication entity devices of the authentication entity devices, a second-stage hash value for the confidential execution content is generated, and the authenticator for the execution content of the authentication subprocess and the second-stage hash value is generated based on the confidential information, and the second-stage authentication context is generated by describing the authenticator, the execution content and the second-stage hash value in accordance with a specified format; hash value comparative verification program code for verifying by comparison that the first-stage hash value and the second-stage hash value contained in the authentication context received are identical to each other; authenticator verification program code for verifying the authenticator for each authentication context based on authenticator verification information stored in the verification device, the authenticator verification information corresponding to confidential information stored in the authentication entity devices; and authentication context verification program code for verifying the legitimacy of the authentication contexts based on the verification result of the verification program code.

10. The program according to item 6, further comprising: profile list generating program code for generating a profile list defining an execution environment acceptable for execution of the authentication subprocesses; and list transmitting program code for transmitting the profile list, the profile list is received by an authentication request device which relays the communication between the verification device and the authentication entity devices, and compared with a function list which is acquired by the authentication request device for each of the authentication entity devices and which defines the function of executing the authentication subprocesses, the comparison is a process for determining an execution profile in such a manner as to meet the requirements of both the profile list and the function list, and the execution profile is transmitted to the authentication entity devices and defines the execution environment for executing the authentication subprocesses.

11. A program stored in a computer-readable storage medium for use in a computer of a authentication request device which relays the communication between the verification device according to item 10 and the authentication entity devices, the program comprising: profile list receiving program code for receiving the profile list from the verification device; function list receiving program code for receiving, for each authentication entity device, the function list defining the function of executing the authentication subprocesses; profile determining program code for determining the execution profile in such a manner as to meet the requirements of both the profile list and the function list; and execution profile transmitting program code for transmitting the execution profile to the authentication entity devices.

12. The program according to item 5, further comprising: wherein the each of authentication entity devices stores link destination information which is for acquiring the static information smaller in data amount than the static information indicating the same content for each authentication; and the authentication context generating program code is to generate the authentication context in such a manner as to include the link destination information in place of the static information, and the authentication context is received by the verification device, the static information is acquired based on the link destination information in the authentication context, and the authentication process is verified based on the static information and the execution content in the authentication context.

13. The program according to item 6, further comprising: program code for acquiring the static information indicating the same content for each authentication session, based on link destination information in the authentication context received by the authentication context receiving program code in the case where the authentication context contains the link destination information, in place of the static information, smaller in data amount than the static information and adapted to acquire the static information; and verification program code for verifying the authentication process based on the static information and the execution content in the authentication context.

As explained above, in the authentication system, apparatus and program according to this invention, the security can be improved against repetitive attacks in which the past authentication contexts are repeatedly used. Also, the security against illegal replacement attacks of the confidential information is improved. Further, the various execution environments of the requesting party can be hidden from the verifiers, etc. Also, the communication efficiency of the authentication context is improved.

What is claimed is:

1. An authentication entity device communicable with a verification device which verifies authentication processes and adapted to individually execute authentication subprocesses making up the authentication process, comprising:
a receiving module configured to receive challenge information generated by the verification device;
a confidential information storage module configured to store confidential information for the verification;
an authenticator generating module configured to generate an authenticator for the execution content of the authentication subprocesses and the challenge information based on the confidential information;
an authentication context generating module configured to generate an authentication context describing the authenticator, the execution content and the challenge information in accordance with a specified format; and
an authentication context transmitting module configured to transmit the authentication context to the verification device,
wherein the authentication context is such that the verification device verifies whether the challenge information identical to the challenge information generated by the verification device is described or not, the authenticator is verified by the verification device based on the authenticator verification information corresponding to the confidential information, and the legitimacy is verified based on the verification result.

2. A verification device communicable with a plurality of authentication entity devices which individually execute authentication subprocesses making up an authentication process and adapted to verify the authentication processes executed by the authentication entity devices, comprising:
a verification information storage module configured to store authenticator verification information corresponding to confidential information stored in the authentication entity devices;
a challenge generating module configured to generate challenge information;
a challenge storage module configured to store the challenge information;
a challenge information transmitting module configured to transmit the challenge information;
an authentication context receiving module configured to receive authentication contexts transmitted from the authentication entity devices after the authentication entity devices generate an authenticator for the execution content of the authentication subprocesses and the challenge information based on the confidential information, and the authentication context is generated by describing the authenticator, the execution content and the challenge information in accordance with a specified format;
a challenge verification module configured to verify whether the challenge information identical to the challenge information in the challenge storage module is described for each authentication context received;
an authenticator verification module configured to verify an authenticator for each of the authentication contexts based on the authenticator verification information; and
an authentication context verification module configured to verify the legitimacy of the authentication contexts based on the verification result by the verification module.

3. At least one first-stage authentication entity device communicable with both a verification device which verifies authentication processes and at least one second-stage authentication entity device included in a plurality of authentication entity devices which individually execute authentication subprocesses making up the authentication process, comprising:
a first-stage hash value generating module configured to generate a first-stage hash value for a confidential execution content included in the execution contents of the authentication subprocesses which is input to a second-stage authentication subprocess and hidden from the verification device;
a first-stage confidential information storage module configured to store confidential information for the verification;
a first-stage authenticator generating module configured to generate an authenticator for the execution content of the authentication subprocesses and the first-stage hash value based on the confidential information;
a first-stage authentication context generating module configured to generate a first-stage authentication context describing the authentication, the execution content for other than the first-stage hash value and the first-stage hash value in accordance with a specified format; and
a first-stage transmitting module configured to transmit the authentication context and the confidential execution content,
wherein the confidential execution content is received by the second-stage authentication entity device and converted into a second-stage hash value for the particular confidential execution content,
the second-stage hash value is converted into an authenticator for the second-stage hash value together with the execution content of the authentication subprocess based on the confidential information by the second-stage authentication entity device on the one hand, and described in the second-stage authentication context in accordance with a specified format together with the authenticator and the execution content while at the same time being transmitted together with the second-stage authentication context on the other hand, and
the authentication contexts are such that the verification device verifies by comparison that the first-stage hash value and the second-stage hash value received and contained in the authentication contexts are identical to each other, and based on the authenticator verification information corresponding to the confidential information, the authenticator is verified for each authentication context thereby to verify the legitimacy based on each verification result.

4. At least one second-stage authentication entity device communicable with both a verification device to verify an authentication process and at least one first-stage authentication entity device among a plurality of authentication entity devices which individually execute authentication subprocesses making up the authentication process, comprising:
a confidential execution content receiving module configured to receive, from the first-stage authentication entity device, a confidential execution content included in the authentication subprocesses which is input to a second-stage authentication subprocess and hidden from the verification device;
a second-stage hash value generating module configured to generate a second-stage hash value for the confidential execution content received;
a second-stage confidential information storage module configured to store confidential information for the verification;
a second-stage authenticator generating module configured to generate an authenticator for the execution content of the authentication subprocess and the second-stage hash value based on the confidential information;
a second-stage authentication context generating module configured to generate an authentication context describing the authenticator, the execution content and the second-stage hash value in accordance with a specified format; and
a second-stage transmitting module configured to transmit the authentication context,
wherein the confidential execution content is converted into a first-stage hash value for the particular confidential execution content by the first-stage authentication entity device before being transmitted from the first-stage entity device,
the first-stage hash value is converted into an authenticator for the first-stage hash value together with the execution content of the authentication subprocess by the first-stage authentication entity device based on the confidential information, while at the same time being described in the first-stage authentication context in accordance with a specified format together with the authenticator and the execution content and transmitted together with the first-stage authentication context, and
the authentication context is such that the verification device verifies by comparison that the first-stage hash value and the second-stage hash value received and contained in the authentication contexts are identical to each other, and based on authenticator verification information corresponding to the confidential information, the authenticator is verified for each authentication context thereby to verify the legitimacy based on each verification result.

5. A verification device communicable with a plurality of authentication entity devices which individually execute authentication subprocesses making up an authentication process and adapted to verify the authentication process executed by each authentication entity device, comprising:
a verification information storage module configured to store authenticator verification information corresponding to confidential information stored in the authentication entity devices;
a first authentication context receiving module operated in such a manner that at least one first-stage authentication entity device among the authentication entity devices generates a first-stage hash value for a confidential execution content included in the execution contents of the authentication subprocesses and input to a second-stage authentication subprocess and hidden from the verification device, an authenticator for the execution content of the authentication subprocess and the first-stage hash value is generated based on the confidential information, and a first-stage authentication context is generated by describing the authenticator, the execution content for other than the first-stage hash value and the first-stage hash value in accordance with a specified format, after which the first-stage authentication context transmitted from the first-stage authentication entity device is received;
a second authentication context receiving module operated in such a manner that at least one second-stage authentication entity device among the authentication entity devices receives the confidential execution content transmitted from the first-stage authentication entity device, a second-stage hash value for the confidential execution content is generated, an authenticator is generated for the execution content of the authentication subprocess and the second-stage hash value based on the confidential information, and a second-stage authentication context is generated by describing the authenticator, the execution content and the second-stage hash value in accordance with a specified format, after which the second-stage authentication context transmitted from the second-stage authentication entity device is received;
a hash value comparative verification module configured to verifying by comparison that the first-stage hash value and the second-stage hash value contained in the received authentication contexts are identical to each other;
an authenticator verification module configured to verify the authenticator for each authentication context based on the authenticator verification information; and
an authentication context verification module configured to verify the legitimacy of each authentication contexts based on the verification result of each verification module.

6. The verification device according to claim 2, comprising:
a profile list generating module configured to generate a profile list specifying an execution environment acceptable for execution of the authentication subprocesses; and
a list transmitting module configured to transmit the profile list,
wherein the profile list is received by an authentication request device which relays the communication between the verification device and each authentication entity device and compared with a function list acquired by the authentication request device for each authentication entity device and specifying the function of executing the authentication subprocesses,
the comparison is a process for determining an execution profiled in such a manner as to meet the requirements of both the profile list and the function list, and
the execution profile is transmitted to the authentication entity devices and specifies the execution environment for execution of the authentication subprocesses.

7. An authentication request device which relays communication between the verification device according to claim 6 and each authentication entity device, comprising:
a profile list receiving module configured to receive the profile list from the verification device;
a function list receiving module configured to receive, for each authentication entity device, the function list specifying the function of executing the authentication subprocesses;
a profile determining module configured to determine the execution profile in such a manner as to meet the requirements of both the profile list and the function list; and
a execution profile transmitting module configured to transmit the execution profile to each authentication entity device.

8. The authentication entity device according to claim 1, comprising:
a link destination information storage module configured to store the link destination information smaller in data amount than the static information indicating the same content for each authentication session to acquire the static information,
wherein the authentication context generating module generates the authentication context in such a manner as to include the link destination information in place of the static information, and
the authentication context is received by the verification device, the static information is acquired based on the link destination information in the authentication context, and based on the static information and the execution content in the authentication context, the authentication process is verified.

9. The verification device according to claim 2, comprising:
a module configured to acquire the static information based on link destination information in the authentication context received by the authentication context receiving module in the case where the authentication context includes the link destination information smaller in data amount than the static information and adapted to acquire the static information indicating the same content for each authentication session in place of the static information; and
a verification module configured to verify the authentication process based on the static information and the execution content of the authentication context.
